(19) United States
(12) Patent Application Publication
(10) Pub. No.: US 2026/0342569 A1
(43) Pub. Date: Oct. 29, 2026

(54) Collaborative-Governance Digital Asset Sovereign Operating System Network with Rooted Domain Trust Anchor, BEI-CD Governance Bridge, BEIFR2 Recovery Tunnel, ToT-SAP Anchoring Protocol, and Lightweight Sovereign Verification

(71) Applicant: FURONG BEI, San Gabriel, CA (US)

(72) Inventor: FURONG BEI, San Gabriel, CA (US)

(21) Appl. No.: 19/688,339

(22) Filed: May 26, 2026

(51) Int. Cl. H04L 9/32

(52) U.S. Cl. CPC H04L 9/32

(57) ABSTRACT

A collaborative-governance digital asset sovereign operating system network includes a Rooted Domain Trust Anchor, BEI-CD Governance Bridge, BEIFR2 Recovery Tunnel, ToT-SAP Anchoring Protocol Engine, and Lightweight Sovereign Verification layer. The bridge maps signed root policy assertions into decentralized execution invariants and receives feedback proofs. When state divergence is detected, BEIFR2 creates a pre-recovery cryptographic snapshot, generates a Forensic Receipt Object, performs bounded forward corrective compensation, and automatically invokes ToT-SAP. ToT-SAP anchors, as a unified domain-separated batch, the pre-recovery snapshot, the receipt, and a post-recovery state in an append-only anchor chain with a rollback-event marker. Prior anchor records remain unmodified while runtime state is corrected through receipt-mediated recovery. Constrained devices verify corrected state using a Merkle proof, rooted-domain signature, and receipt validation object without synchronizing a full consensus ledger.

### TECHNICAL FIELD

The disclosed technology relates to distributed computing, cryptographic control planes, domain-origin trust anchors, decentralized execution environments, temporal ledger anchoring, forensic recovery, edge verification, and network operating system governance. The disclosed embodiments are directed to a collaborative-governance digital asset sovereign operating system network that separates historical cryptographic auditing from runtime state execution while preserving a deterministic relationship between centralized control policies and decentralized empirical ledger states.

The disclosed technology provides machine-executable mechanisms by which a rooted policy authority can coexist with a distributed ledger or decentralized processing environment. The architecture converts root policy assertions into verifiable execution invariants, detects divergence between a trusted root and empirical decentralized state, performs bounded recovery through a forensic receipt, and forces the recovery evidence into an append-only temporal anchor chain.

The disclosure is intended to support implementations as software services, kernel services, smart-contract adapters, validator plugins, hardware enclave routines, embedded firmware, edge verification libraries, or distributed operating system components. The disclosure is not limited to a particular blockchain, vendor, programming language, certificate vendor, commercial domain name, or deployment topology.

### BACKGROUND AND TECHNICAL PROBLEM

Conventional decentralized ledgers emphasize immutability. Once a state is committed, the record is difficult to correct without a hard fork, manual intervention, or a non-technical governance vote. Conventional centralized systems allow correction, but frequently do not preserve a cryptographically independent audit trail. The unresolved engineering problem is how a network can preserve immutable historical evidence while permitting bounded and verifiable recovery of runtime state.

Existing bridges, decentralized identity systems, light clients, and time-stamping systems typically treat policy mapping, recovery, anchoring, and verification as separate operations. Such systems may anchor an item, prove an identity, or perform a localized correction, but they do not require a recovery receipt to trigger temporal anchoring of a pre-recovery snapshot, the receipt itself, and the post-recovery state as a unified batch payload.

Prior systems therefore expose a fundamental conflict. If historical immutability is absolute, a corrupt or unauthorized runtime state may remain effective. If an administrator can alter the state without independent anchoring, the historical record can be weakened or hidden. The disclosed system addresses this conflict by separating historical anchor immutability from runtime state recoverability while binding both through forced receipt-to-anchor linkage.

### SUMMARY OF THE INVENTION

The invention provides a sovereign infrastructure protocol stack. In representative embodiments, the stack includes a Rooted Domain Trust Anchor Module, a BEI-CD Governance Bridge, a BEIFR2 Recovery Tunnel Sub-system, a ToT-SAP Anchoring Protocol Engine, and a Lightweight Sovereign Verification layer. These modules cooperate to map rooted policy assertions to decentralized execution invariants, detect state divergence, generate a forensic receipt, perform bounded correction, append recovery evidence to an anchor chain, and allow constrained devices to verify the resulting state.

The central technical improvement is dual-layer immutability. Historical anchor records are not deleted, muted, or modified. Runtime state can nevertheless be corrected by a bounded forward corrective compensation transition. The correction itself becomes a cryptographic event represented by a Forensic Receipt Object and forced into a ToT-SAP Anchor Chain. The network therefore creates a persistent evidentiary history of both the deviant state and the corrective state.

Upon generation or authorization of the Forensic Receipt Object, the BEIFR2 Recovery Tunnel Sub-system automatically and mandatorily invokes the ToT-SAP Anchoring Protocol Engine. The anchoring engine anchors, as a unified domain-separated batch, at least a pre-recovery cryptographic snapshot, the Forensic Receipt Object, and a post-recovery state. A resulting anchor record includes a rollback-event marker identifying that the anchor record corresponds to a bounded recovery operation.

The forced linkage is a protocol invariant rather than a discretionary administrative step. If a receipt exists without a corresponding anchor, the receipt remains pending or subject to retry. If an anchor appears without a valid receipt, a verifier can reject or downgrade the anchor. This cross-layer dependency causes runtime correction and historical audit evidence to remain synchronized.

### Technical Distinction Over Conventional Approaches

Various conventional systems perform Merkle anchoring, timestamping, decentralized identity verification, bridge synchronization, or ledger recovery. The disclosed system does not merely add one such component to another. The disclosed system enforces a cross-layer atomic linkage in which the recovery protocol and the temporal anchoring protocol move together through defined state transitions.

In conventional recovery systems, correction may be performed by hard fork, administrator override, or localized rollback. Such correction may either break historical continuity or fail to create a cryptographically linked evidence record inside the primary anchor lineage. In conventional anchoring systems, an anchor may record a data item or Merkle root, but the anchor is generally independent from a recovery receipt and is not forced to include pre-recovery, recovery, and post-recovery evidence in one domain-separated batch.

In contrast, the disclosed system requires that generation or authorization of a Forensic Receipt Object automatically cause ToT-SAP to anchor the pre-recovery snapshot, the receipt, and the post-recovery state as a unified batch. The anchor includes a rollback-event marker and can include a receipt identifier, pre-recovery Time-of-Time summary, post-recovery Time-of-Time summary, bounded rollback scope, and anchor mode. The architecture therefore provides verifiable correction without sacrificing historical auditability.

The combination of a structured Forensic Receipt Object as a first-class protocol element, mandatory batch anchoring of the pre-recovery snapshot, receipt, and post-recovery state, and explicit rollback-event marking in the append-only anchor chain provides a technical effect not achieved by systems that treat recovery and anchoring as independent or loosely coupled operations.

### Design Invariants

| Invariant | Technical Function |
|---|---|
| Zero Mutation | Prior historical anchor records are preserved as |
| Invariant | append-only evidence and are not deleted, muted, |
| | overwritten, or silently corrected. |
| Bounded | Runtime state correction occurs only within a |
| Recovery | bounded scope determined by policy, trigger vectors, |
| Invariant | namespace boundaries, asset classes, and time |
| | intervals. |
| Receipt First- | A recovery operation produces a serialized |
| Class Object | Forensic Receipt Object that identifies the snapshot, |
| Invariant | trigger, scope, authority, anchor reference, rebind |
| | state, audit window, and signature. |
| Forced Anchor | A generated or authorized receipt automatically |
| Invariant | invokes ToT-SAP anchoring of the pre-recovery |
| | snapshot, receipt, and post-recovery state. |
| Lightweight | A constrained device can evaluate a corrected state |
| Verification | by verifying compact proof material rather than |
| Invariant | synchronizing a global consensus ledger. |

### DEFINITIONS

| Term | Technical Meaning |
|---|---|
| Rooted Domain | a domain-origin authority module, certificate |
| Trust Anchor | hierarchy, hardware-backed key boundary, secure |
| | enclave, transparency log, or equivalent authoritative |
| | cryptographic root that signs, validates, or derives |
| | machine-readable control policy assertions. |
| BEI-CD | a control-plane bridge that compiles centralized |
| Governance | structural policy assertions into decentralized execution |
| Bridge | invariants and maps decentralized feedback proofs |
| | back to the trusted root. |
| BEIFR2 | a bounded forensic recovery tunnel that detects |
| Recovery | state divergence, creates a cryptographic snapshot, |
| Tunnel | generates a forensic receipt, performs forward |
| | corrective compensation, and causes post-correction |
| | anchoring without rewriting history. |
| ToT-SAP | a temporal anchoring protocol that serializes Time- |
| Anchoring | of-Time state records, enhanced Merkle roots, receipts, |
| Protocol | snapshots, rollback-event markers, and re-anchored |
| | state outputs into an append-only anchor chain. |
| Forensic | a structured protocol object containing a receipt |
| Receipt | identifier, snapshot hash, trigger vector, rollback scope, |
| Object | hub threshold record, anchor reference, rollback-event |
| | descriptor, rebind state, audit window, receipt hash, |
| | and receipt signature. |
| Lightweight | a constrained-device verification protocol that |
| Sovereign | validates a Merkle proof, rooted-domain signature, and |
| Verification | receipt object without operating as a full consensus |
| | node. |
| Time-of-Time | a monotonic temporal state record that may |
| Record | include an interval, value delta, identity commitment, |
| | prior hash link, fission reference, receipt reference, |
| | anchor reference, and signature. |
| Rollback-Event | a machine-readable marker in an anchor record |
| Marker | indicating that the anchor corresponds to a bounded |
| | recovery operation and not to an ordinary transaction- |
| | only anchor. |
| Rebind State | a post-correction root binding, key state, |
| | namespace binding, policy topology, or state proof by |
| | which an affected state is realigned with the Rooted |
| | Domain Trust Anchor. |

### BRIEF DESCRIPTION OF THE DRAWINGS

FIG. 1 illustrates an overall collaborative-governance digital asset sovereign operating system network.

FIG. 2 illustrates a five-layer protocol stack including root, governance, recovery, anchoring, and verification layers.

FIG. 3 illustrates an example Rooted Domain Trust Anchor module.

FIG. 4 illustrates an example BEI-CD Governance Bridge.

FIG. 5 illustrates an example ToT tuple and ledger data model.

FIG. 6 illustrates an example ToT-SAP Anchor Engine.

FIG. 7 illustrates an example BEIFR2 Recovery Tunnel.

FIG. 8 illustrates an example Forensic Receipt Object.

FIG. 9 illustrates an example Receipt State Machine.

FIG. 10 illustrates an example Anchor State Machine.

FIG. 11 illustrates a mandatory cross-layer atomic linkage between a receipt and an anchor transition.

FIG. 12 illustrates dual-layer immutability separating historical anchor immutability from stateful recoverability.

FIG. 13 illustrates forced anchoring of a pre-recovery snapshot, forensic receipt, and post-recovery state.

FIG. 14 illustrates an enhanced Merkle leaf structure.

FIG. 15 illustrates Lightweight Sovereign Verification.

FIG. 16 illustrates post-recovery rebinding logic.

FIG. 17 illustrates hub threshold verification.

FIG. 18 illustrates a regulatory minimal-view module.

FIG. 19 illustrates layered anomaly detection.

FIG. 20 illustrates bounded scope calculation.

FIG. 21 illustrates forward correction compensation.

FIG. 22 illustrates anchor failure recovery.

FIG. 23 illustrates edge-device verification environments.

FIG. 24 illustrates interoperability adapters.

FIG. 25 illustrates a security assurance matrix.

FIG. 26 illustrates deployment environments for the protocol stack.

### OVERALL ARCHITECTURE

In one embodiment, the Rooted Domain Trust Anchor sits at a root protocol layer. Below the root layer, the BEI-CD Governance Bridge executes a real-time mapping between root policy assertions and decentralized node states. A recovery protocol layer includes the BEIFR2 Recovery Tunnel, which monitors divergence and invokes recovery. A temporal anchoring layer includes ToT-SAP, which creates primary and optional secondary anchors for time-series state. A verification layer includes LSV, which allows edge nodes to validate asset state without performing full ledger synchronization.

The architecture is intentionally split into historical and runtime planes. The historical plane is append-only and responsible for auditability. The runtime plane is adjustable only through bounded recovery. The planes are linked by receipts and anchor events. This separation prevents a correction mechanism from becoming an arbitrary administrator switch while also preventing immutability from locking the system into a permanently corrupt or unauthorized state.

The modules may be deployed in a single computing environment or distributed across multiple nodes. The Rooted Domain Trust Anchor may be operated by a root authority. The BEI-CD Governance Bridge may execute as a control-plane service. BEIFR2 may execute as an asynchronous recovery daemon. ToT-SAP may execute as an anchoring service. LSV may execute as firmware, a mobile secure enclave routine, a vehicle computing unit routine, an AI-agent module, or an embedded verifier.

### Rooted Domain Trust Anchor Module

The Rooted Domain Trust Anchor maintains an authoritative cryptographic root state. It can generate a policy hash, issue a signed invariant vector, and bind a namespace, node class, asset class, or execution domain to a policy set. A policy assertion may identify allowed state transitions, authorized verification keys, accepted hub thresholds, allowed rollback windows, permitted asset classes, and minimum anchor modes.

The root improves the network by converting centralized authority into cryptographic input rather than human discretion. The root does not simply instruct nodes. It generates machine-verifiable conditions that downstream modules can test, allowing decentralized systems to receive centralized structure while retaining cryptographic auditability.

A signed policy assertion may include a policy identifier, policy version, namespace range, validity interval, key identifier, threshold requirement, recovery window, maximum affected-asset class, root signature, and monotonic nonce. The monotonic nonce assists in replay prevention. The validity interval prevents stale policy assertions from authorizing new recovery events.

### BEI-CD Governance Bridge

The BEI-CD Governance Bridge is a bidirectional mapping engine. In a downward direction, it receives root policy assertions and compiles them into execution invariants for decentralized nodes. In an upward direction, it receives empirical state proofs, anchor receipts, hub signatures, Merkle roots, anomaly metrics, and receipt state and maps those data back to the Rooted Domain Trust Anchor.

The bridge may maintain parity thresholds. If empirical state diverges from a compiled invariant beyond a threshold, the bridge may issue a divergence interrupt vector. The interrupt vector initiates validation, snapshotting, receipt generation, anchoring, correction, rebinding, and audit logging, but does not by itself rewrite state.

The bridge establishes a technical relationship between root policy and decentralized execution. In some implementations, the bridge maintains predicates over ledger state, node identity state, anchor state, receipt state, policy state, hub signature state, and rebind state. Each predicate can include an evaluation function, failure code, threshold, and remediation mode.

### ToT Ledger and ToT Value State

The ToT Ledger stores time-indexed protocol records. A record may include a prior tuple hash, monotonic interval, value delta, identity commitment, fission reference, hash-root proof, anchor identifier, receipt reference, and signature. The value delta is treated as a computable data field, so the ledger records temporal state transitions rather than merely recording timestamps.

In certain embodiments, a ToT value state is computed using evidence vectors. A representative form is an accumulated sum or integral of behavioral evidence, fission weights, and hash-integrity factors across a temporal interval. The implementation may use fixed-point arithmetic, integer accumulation, vector scoring, or another deterministic operation suitable for ledger execution.

A ToT record may be used both for ordinary transaction anchoring and for recovery anchoring. When associated with a recovery operation, the ToT record can include a rollback-event marker, pre-recovery summary, post-recovery summary, receipt identifier, rebind state reference, and anchor mode. These fields allow later verification of the correction lineage.

### ToT-SAP Anchoring Protocol Engine

The ToT-SAP engine receives anchor requests triggered by time-slice intervals, receipt events, rollback events, policy updates, or rebind events. The engine builds enhanced Merkle leaves that can bind a ToT delta, identity commitment, fission reference, hash-root proof, receipt reference, policy hash, nonce, and domain separator. The engine constructs a Merkle root and serializes an anchor object.

The anchor object may be stored in a primary Rooted Domain anchor and optionally in a secondary consensus anchor. The primary anchor can provide sovereign control. The secondary anchor can provide independent redundancy. A hybrid anchor can bind both, allowing the system to combine root authority with external verifiability.

The engine may operate under an Anchor State Machine having Pending, Anchored, HybridAnchored, Verified, RollbackAdjusted, ReAnchored, and Archived states. The state machine ensures that normal records can be verified and archived, while abnormal records can be adjusted through a receipt-mediated path without deletion of prior records.

### BEIFR2 Recovery Tunnel

The BEIFR2 Recovery Tunnel detects an anomaly, verifies triggering conditions, creates a cryptographic snapshot, calculates a bounded recovery scope, executes a state correction, generates a forensic receipt, invokes ToT-SAP anchoring, verifies hub authorization, rebinds affected states, verifies hash-chain integrity, and emits an audit event. The recovery tunnel is a deterministic recovery runtime with multiple cryptographic gates.

In a representative implementation, BEIFR2 distinguishes irreversible time records from conditionally reversible runtime states. The time record is not rolled back. A new record is appended that documents the recovery event. The runtime state can be corrected by applying a forward corrective compensation vector to a localized state namespace.

The recovery tunnel can reject an attempted recovery when liveness, replay prevention, scope safety, policy authorization, hub threshold, or non-duplication checks fail. Rejection can produce a machine-readable failure code, allowing downstream systems to distinguish invalid, pending, quarantined, and corrected states.

### Forensic Receipt Object

The Forensic Receipt Object is a protocol-native evidence object. It may include a receipt identifier, receipt type, snapshot hash, trigger vector, rollback scope, affected assets, BEI liveness proof, hub threshold, anchor reference, rollback-event descriptor, pre-recovery ToT summary, post-recovery ToT summary, rebind state, audit window, receipt hash, and receipt signature.

The receipt is serialized and signed so that later verification can determine what happened, why it happened, what was affected, who or what authorized it, what anchor records were generated, and how the corrected state was rebound. The receipt therefore converts an exceptional recovery operation into a technical evidence object.

A verifier can evaluate the receipt signature, compare the snapshot hash to a prior anchor, verify bounded scope, inspect the trigger vector, evaluate the hub threshold, and determine whether the resulting anchor includes the rollback-event marker. This avoids reliance on subjective governance descriptions.

| Field | Data Type | Function |
|---|---|---|
| receipt_id | UUID or monotonic | Identifies a receipt instance |
| | identifier | and supports chronological |
| | | recovery lineage. |
| snapshot_hash | hash value | Commits to pre-recovery state |
| | | and preserves forensic |
| | | evidence. |
| rollback_scope | structured object | Defines affected namespace, |
| | | nodes, assets, time interval, |
| | | and state keys. |
| trigger_vector | byte array or | Encodes anomaly source, |
| | structured vector | divergence metric, trigger |
| | | logic, and policy threshold. |
| hub_threshold | signature aggregate | Records M-of-N authorization |
| | or count record | or equivalent validator |
| | | approval. |
| anchor_reference | primary and optional | Binds the receipt to ToT-SAP |
| | secondary reference | anchor records. |
| rollback_event | operation or delta | Identifies the correction vector |
| | descriptor | or deterministic compensation |
| | | transition. |
| rebind_state | root binding or | Identifies post-correction |
| | state proof | binding to policy and trust |
| | | root. |
| audit_window | block or time | Defines challenge period and |
| | interval | finality condition. |
| receipt_signature | cryptographic | Protects the receipt object |
| | signature | against alteration. |

### Cross-Layer Atomic Transition

A key aspect of the invention is the cross-layer atomic transition between the Receipt State Machine and the Anchor State Machine. When a receipt enters an authorized state, the BEIFR2 Recovery Tunnel emits ROLLBACK_SIGNAL(r). The ToT-SAP Anchor State Machine receives the signal and transitions an affected verified anchor into RollbackAdjusted. BEIFR2 then applies a bounded forward compensation vector. ToT-SAP serializes the receipt, prior snapshot, and post-correction state as a unified anchor payload and creates a new ReAnchored state.

This cross-layer transition prevents hidden or partial recovery. If a receipt exists without an anchor, the receipt is pending and subject to retry or governance alert. If an anchor exists without a valid receipt, a verifier can reject the anchor or treat it as untrusted. The cross-layer dependency therefore ensures that runtime correction and historical evidence remain synchronized.

In one implementation, the signal includes a receipt identifier, snapshot hash, bounded rollback scope, policy hash, post-correction state hash, trigger vector, and anchor mode. The anchor request formed by ToT-SAP includes a context field indicating BEIFR2_ROLLBACK. A domain-separated Merkle tree is then formed over the snapshot leaf, receipt leaf, post-state leaf, policy leaf, and optional ToT delta leaf.

### Forced BEIFR2 and ToT-SAP Linkage

After BEIFR2 generates or authorizes a receipt, ToT-SAP is automatically invoked. The invocation may include a batch payload containing the pre-recovery ToT snapshot, the Forensic Receipt Object, and the post-recovery state object. The resulting anchor includes a rollback-event marker, a receipt identifier, a pre-recovery ToT summary, a post-recovery ToT summary, and a bounded rollback scope.

The forced linkage is not merely a scheduling preference. It is an invariant of the recovery protocol. If ToT-SAP primary anchoring fails, the receipt can enter a pending_anchor state, a deterministic retry mechanism can execute, and a governance alert can be emitted. In some embodiments, a secondary anchor can be used as a temporary or redundant anchor until the primary anchor resumes.

The forced linkage converts a recovery operation into an auditable anchor-chain event. A network node, auditor, edge verifier, or smart-contract adapter can later inspect the anchor and determine that the state change was not an ordinary transfer but a bounded recovery operation supported by a receipt and snapshot.

### Failure Compensation and Retry

The system may implement a deterministic retry and compensation mechanism. A primary anchor failure can cause the engine to record pending anchor status, preserve the receipt hash, preserve the snapshot hash, store the post-correction state hash, and schedule retry attempts under a backoff policy. If a secondary anchor is available, the secondary anchor may store a provisional proof. When the primary anchor is restored, the provisional proof can be reconciled and a primary re-anchor can be created.

The retry mechanism is designed to avoid inconsistent recovery. The runtime correction may be allowed to proceed under a bounded quarantine mode only when a valid receipt exists and when the correction scope is limited. Alternatively, a policy may require the corrected state to remain non-final until a primary anchor confirms. In both cases, the receipt and anchor state machine identify the state of the recovery and the verification level available to downstream devices.

A retry record may include a retry counter, backoff interval, failure reason, anchor mode, receipt identifier, prior anchor reference, provisional anchor reference, and reconciliation status. Such record allows later systems to distinguish a permanently failed recovery attempt from a delayed but reconciled recovery event.

### Multiple Rollback Anchor Chain Evolution

When multiple recovery events occur, the system does not collapse or erase the events. Each recovery event creates a receipt, a rollback marker, and a re-anchored state. The anchor chain evolves as a sequence of verified, adjusted, and re-anchored states. A later verifier can reconstruct the recovery lineage by following receipt identifiers, prior anchor references, and post-correction state hashes.

This evolution is materially different from a conventional hard fork or database rollback. A hard fork may create discontinuity and political ambiguity. A database rollback may erase evidence. In the disclosed system, the sequence remains visible: verified anchor, recovery receipt, rollback adjusted anchor, re-anchored state, and archived audit window.

A second receipt may reference a first receipt identifier. A third receipt may reference the post-correction state of the second recovery. Because each receipt is anchored and each re-anchored state includes prior references, a verifier can walk the chain of corrections without off-chain explanation.

### Enhanced Merkle Tree Construction

Enhanced Merkle leaves may include a serialized tuple of fields: ToT value delta, BEI identity commitment, fission reference, hash-root proof, receipt reference, anchor context, policy hash, nonce, and domain separator. A leaf hash may be computed as H (domain_separator∥serialized_leaf∥policy_hash∥nonce). Domain separation prevents cross-protocol confusion.

The enhanced Merkle tree allows a compact proof to establish several facts simultaneously: that a time-slice record exists, that a value delta is part of the record, that the record is bound to an identity commitment, that it is linked to a fission reference, that it references a receipt when applicable, and that it is within a known anchor.

Domain-separated leaf types may include SNAPSHOT, RECEIPT, POST_STATE, TOT_DELTA, POLICY, REBIND_STATE, and HUB_SIGNATURE_SET. These domain tags reduce the risk that a malicious actor can substitute a receipt hash for a state hash or a snapshot hash for a policy hash.

### Lightweight Sovereign Verification

Lightweight Sovereign Verification allows an edge device to validate legitimacy without running a full consensus node. The device receives a Merkle proof, a Rooted Domain signature, and a receipt validation object. The device computes the Merkle path, verifies the root signature or anchor signature, and checks whether any receipt affects the asset namespace.

If no receipt applies, the asset state is accepted under ordinary anchor verification. If a receipt applies, the verifier uses the rebind state or post-correction hash identified by the receipt. This allows offline or low-connectivity devices to remain aligned with the corrected sovereign state.

The LSV layer is useful for AI agents, medical devices, mobile wallets, vehicle computing units, IoT processors, hardware keys, and embedded assets. These nodes may have limited power, memory, network access, or time. The invention allows them to verify current governance status using compact evidence rather than synchronizing a full ledger.

### Regulatory Minimal View

In some embodiments, a regulatory minimal-view module generates a cryptographic compliance assertion using zero-knowledge, commitment, selective disclosure, or equivalent logic. The module can provide a verification result without exposing raw behavioral economic evidence, private identity data, or complete ToT state records.

A minimal-view proof may indicate whether an asset state is authorized, frozen, corrected, pending, archived, or outside scope. It may include a policy hash, root signature, Merkle proof, receipt reference, and boolean assertion. The proof can assist compliance review while reducing unnecessary disclosure of underlying data.

This module supports the broader architecture by allowing centralized oversight to coexist with decentralized execution. It avoids a false choice between total opacity and full raw-data exposure.

### Security Model

| Threat Class | Technical Mitigation |
|---|---|
| Bridge attack | Detected by parity divergence between root policy |
| | assertions and empirical ledger states. |
| Replay attack | Mitigated by monotonic nonces, receipt identifiers, |
| | trigger nonces, and anchor references. |
| Governance | Mitigated by hub threshold signatures, audit |
| capture | windows, and rooted policy constraints. |
| Temporal drift | Mitigated by ToT interval consistency, anchor- |
| | chain verification, and prior-hash linkage. |
| Anchor | Mitigated by pending-anchor state, secondary |
| suppression | anchor, deterministic retry, and reconciliation anchor. |
| Cross-object | Mitigated by domain-separated Merkle leaves and |
| substitution | typed anchor payloads. |
| Unbounded | Mitigated by policy-defined scope safety, maximum |
| correction | recovery windows, and affected-asset limitations. |

### Representative Algorithms

A representative recovery algorithm can include the following operations: receive a divergence interrupt vector; verify root policy validity; verify BEI liveness or equivalent actor authorization; verify replay prevention; create a cryptographic snapshot; calculate bounded scope; determine whether the scope is safe; generate a receipt; request hub threshold approval if required; emit ROLLBACK_SIGNAL(r); invoke ToT-SAP; apply a forward correction vector; rebind affected state; verify the hash chain; and emit an audit event.

A representative ToT-SAP anchoring algorithm can include the following operations: receive an anchor request; validate the anchor context; classify the request as ordinary, policy update, receipt anchor, rollback event, rebind event, or retry event; create domain-separated leaves; build an enhanced Merkle root; create primary anchor; optionally create secondary anchor; update the Anchor State Machine; return anchor reference to BEIFR2; and write an anchor audit event.

A representative LSV algorithm can include the following operations: receive credential and proof bundle; compute the Merkle path; verify the anchor or root signature; identify whether a receipt applies to the asset namespace; verify receipt signature and scope; apply rebind state if required; and output ordinary, corrected-state, pending-anchor, rejected, or archived verification status.

### Implementation Details

In some embodiments, modules may execute as microservices, kernel services, smart-contract adapters, enclave services, validator plugins, edge device firmware, or distributed operating system components. A Rooted Domain Trust Anchor may run inside a hardware security module or trusted execution environment. BEI-CD may run as a policy compiler and state synchronizer. BEIFR2 may run as an asynchronous recovery service. ToT-SAP may run as a ledger anchoring service.

Messages among modules may be serialized using JSON, CBOR, TLV, protocol buffers, ASN.1, or another deterministic encoding. Hashes may be computed using SHA-2, SHA-3, BLAKE, Poseidon, or another collision-resistant function suitable for the target environment. Signatures may be ECDSA, EdDSA, BLS threshold signatures, post-quantum signatures, or equivalent schemes, depending on implementation requirements.

The claims and embodiments are not limited to a particular hardware security module, trusted execution environment, blockchain, certificate provider, or network operator. The disclosed architecture is defined by the relationships among rooted policy assertions, bridge mapping, bounded recovery, forensic receipts, forced anchoring, and lightweight verification.

### Example Operation

In an example operation, a Rooted Domain Trust Anchor issues policy assertion P_n. BEI-CD compiles P_n into execution invariant I_n. Decentralized nodes execute transactions under I_n and produce ToT records. ToT-SAP anchors the records in anchor A_n. Later, a sentinel detects that a namespace deviates from I_n. BEIFR2 verifies the trigger, creates snapshot S_n, calculates bounded scope B_n, and generates receipt R_n.

Upon generation or authorization of R_n, ToT-SAP is forced to anchor S_n, R_n, and the post-correction state C_n as a unified batch. The anchor includes rollback event=true. BEI-CD maps the corrected state back to the root and verifies parity. The prior anchor A_n remains historical evidence and is not deleted or rewritten.

An edge device later receives a credential referencing the affected namespace. The device performs LSV. It verifies a Merkle proof against the anchor chain, verifies the rooted signature, and verifies the receipt. Because the receipt scope covers the namespace, the device recognizes the rebind state and uses the corrected state rather than the deviant state.

### Detailed Protocol Engineering Disclosure

The machine-executable control flow begins when a policy assertion is serialized by the Rooted Domain Trust Anchor. The assertion includes a policy identifier, policy version, namespace range, validity interval, key identifier, threshold requirement, recovery window, and signature. BEI-CD receives the assertion and compiles it into an invariant vector represented as a sequence of predicates over ledger state, node identity state, anchor state, and receipt state.

The divergence metric can be computed using a weighted function over multiple signals. Signals may include hash deviation, signature mismatch, missing anchor reference, invalid nonce order, contradictory hub signature, ToT drift, policy violation, or receipt inconsistency. The resulting trigger vector is recorded in the receipt so that later nodes can understand and verify why recovery was initiated.

When an anomaly is detected, BEIFR2 does not immediately perform correction. It first verifies liveness, replay resistance, root-policy validity, scope safety, and non-duplication of the trigger nonce. Liveness verification can require a current signature, nonce, timestamp, device-bound attestation, or hub challenge. Scope safety can compare requested rollback scope against maximum scope, maximum time window, and allowed asset classes.

The snapshot operation captures a cryptographic commitment to the current state. The snapshot may include a ToT ledger root, node state root, BEI binding table root, policy snapshot, hub validator set root, and pending transaction queue root. These subroots can be assembled into a snapshot root and included in the receipt and anchor batch.

The bounded scope computation identifies affected nodes, assets, namespaces, state keys, time intervals, and policy assertions. The scope may be computed using dependency graphs, namespace boundaries, transaction ancestry, asset lineage, or hub validator topology. If attempted recovery exceeds a policy-defined scope, the recovery tunnel rejects the operation or escalates it to a higher governance mode.

The compensation transition can be viewed as a forward correction. Rather than modifying a prior block, the system produces a current-time correction vector. The vector may include state additions, state nullifications, rebind instructions, frozen-output flags, release flags, or settlement offsets. The post-correction state hash is derived from the prior valid checkpoint, bounded scope, and compensation vector.

The Forensic Receipt Object has its own lifecycle. It begins in Created state when fields are assembled, moves to Pending after initial signatures are added, moves to Authorized after threshold validation, moves to Executed after the compensation transition is applied, moves to Anchored when ToT-SAP creates an anchor containing the receipt, and moves to Finalized after the audit window closes.

The Anchor State Machine has explicit transitions. Pending means the anchor payload has been formed but not committed. Anchored means a primary anchor has been created. HybridAnchored means a secondary anchor or redundant external proof has been created. Verified means the anchor has passed root and consensus validation. RollbackAdjusted means an anomaly and recovery receipt affected the anchor lineage. ReAnchored means a post-correction anchor has been appended. Archived means the audit window has closed.

The cross-layer atomic logic ensures that a recovery receipt and an anchor transition remain consistent. When a receipt reaches Authorized state, BEIFR2 emits a rollback signal. ToT-SAP consumes the signal and forms an anchor request containing the pre-recovery snapshot, receipt object, post-recovery state hash, and BEIFR2_ROLLBACK context. If the anchor fails, the receipt cannot be falsely finalized.

The disclosed protocol stack can be implemented in a modular way. The Rooted Domain component can be a key management service. BEI-CD can be a policy compiler and synchronization bus. ToT-SAP can be an anchoring service. BEIFR2 can be a recovery daemon. LSV can be an SDK or embedded firmware library. The claims are not limited to a particular vendor, chain, language, or topology.

### INDUSTRIAL APPLICABILITY

The disclosed system may be used in digital asset networks, cross-border settlement systems, regulated token exchanges, AI-agent execution networks, medical data devices, IoT identity systems, domain-origin identity networks, recovery-aware ledgers, sovereign identity wallets, compliance gateways, and distributed operating systems requiring both audit immutability and controlled correction.

The invention is particularly useful where regulated infrastructure cannot accept uncontrolled decentralization, but decentralized execution cannot accept opaque centralized edits. The disclosed protocol stack provides a technical bridge that preserves evidence while allowing bounded recovery.

The layered design supports implementation by vertical modules. A financial settlement environment may use Rooted Domain, BEI-CD, BEIFR2, and ToT-SAP. An AI-agent or IoT environment may use LSV and receipt validation. A healthcare or compliance environment may use minimal-view proofs and recovery lineage. These deployments remain within the same technical architecture.

### Figure-Specific Operational Support

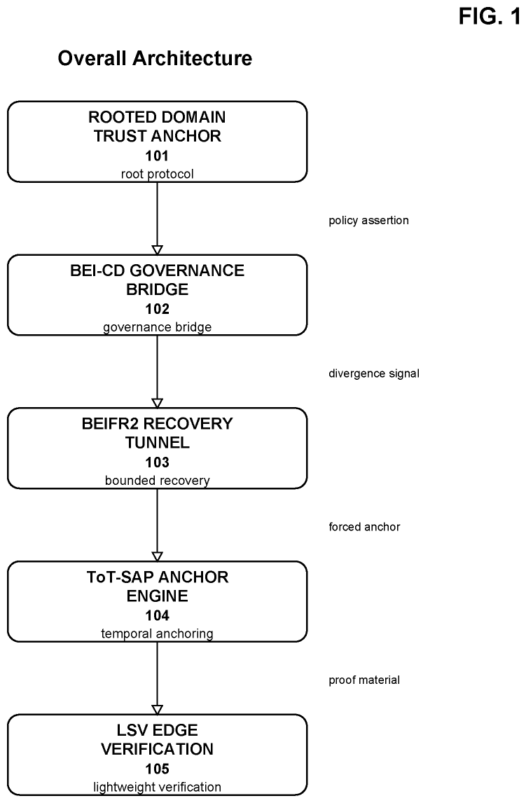

With respect to FIG. 1, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 1, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

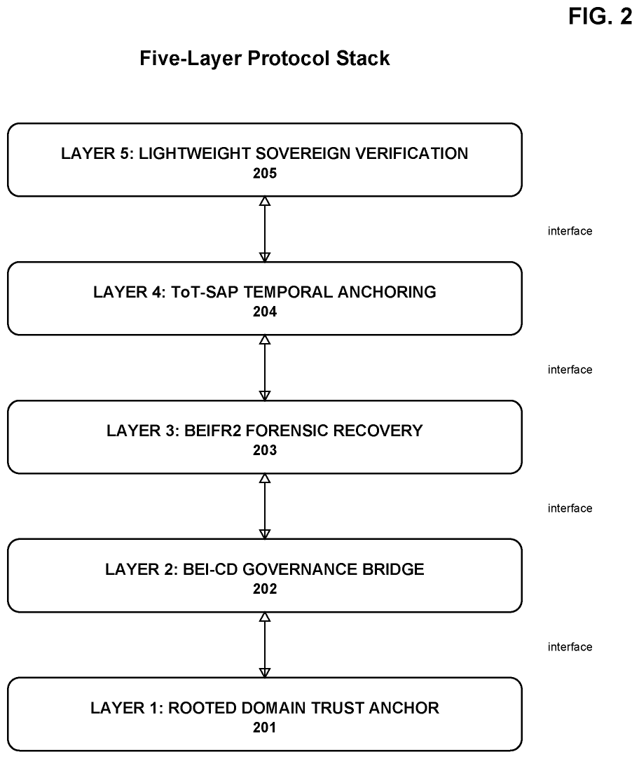

With respect to FIG. 2, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 2, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

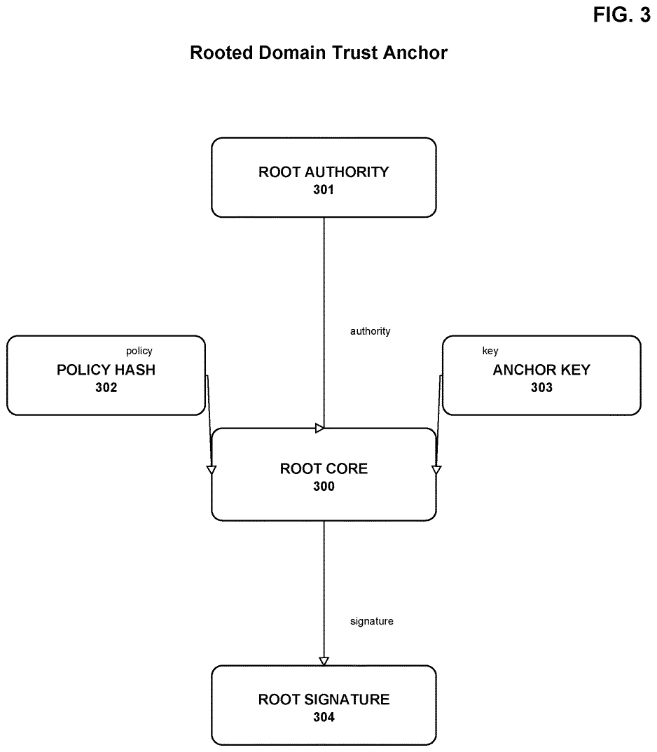

With respect to FIG. 3, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

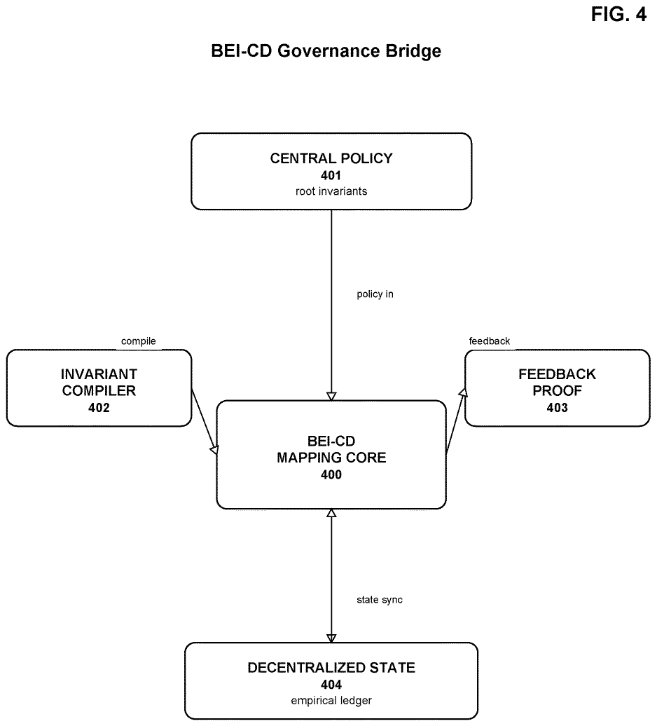

With respect to FIG. 4, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

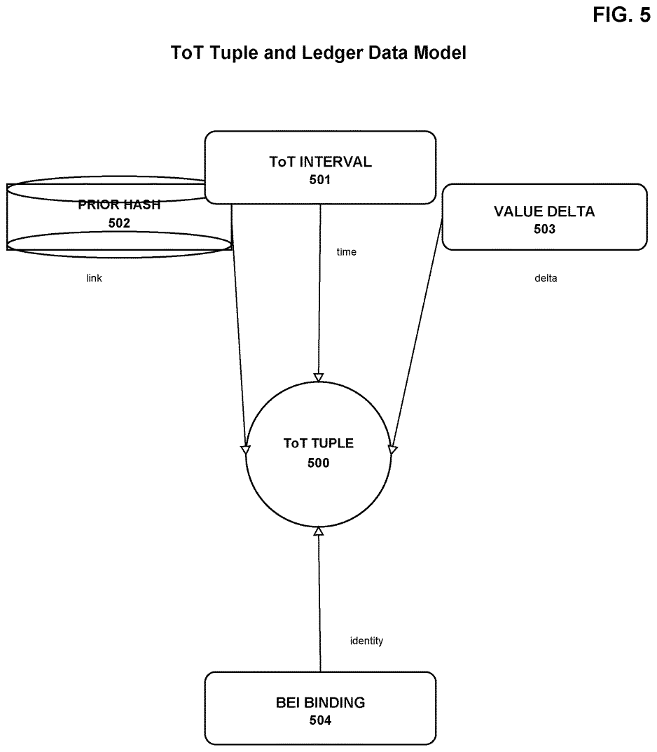

With respect to FIG. 5, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

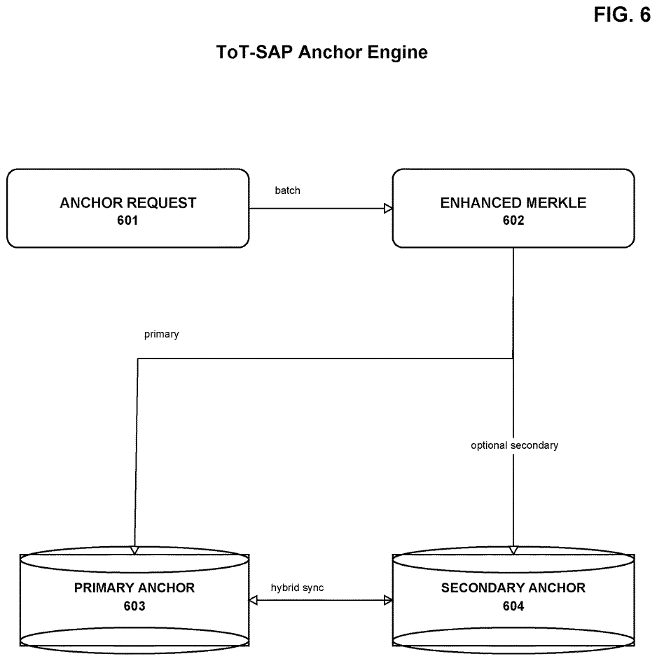

With respect to FIG. 6, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

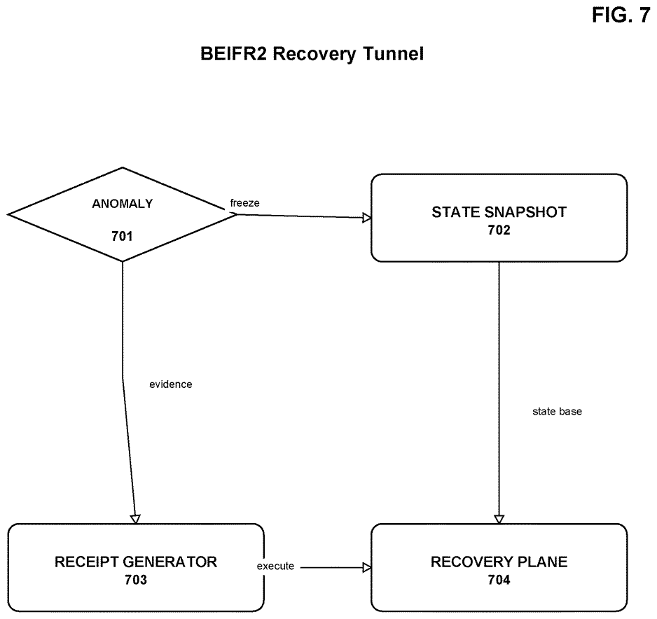

With respect to FIG. 7, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 7, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

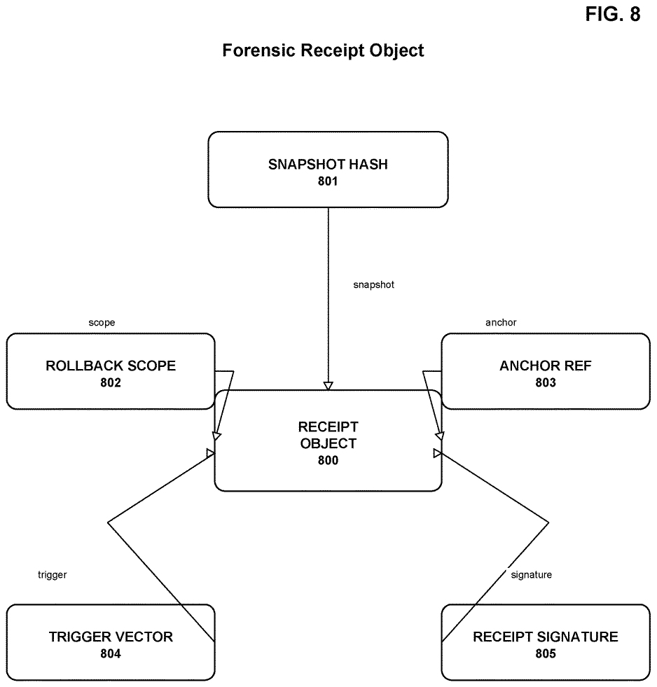

With respect to FIG. 8, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 8, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

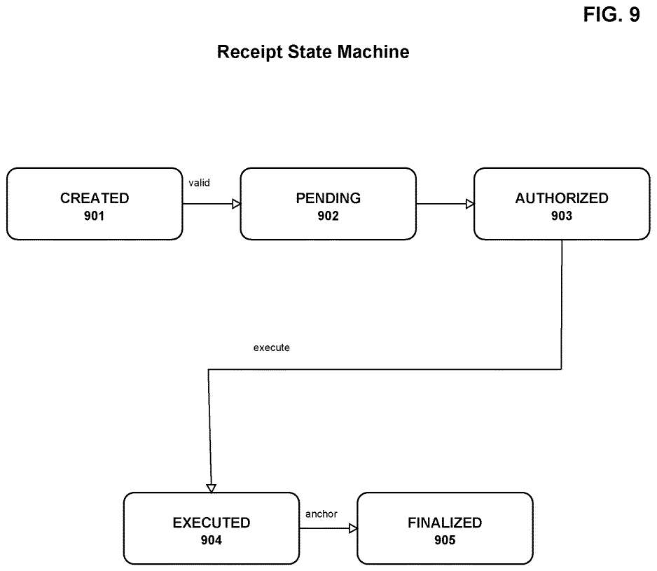

With respect to FIG. 9, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

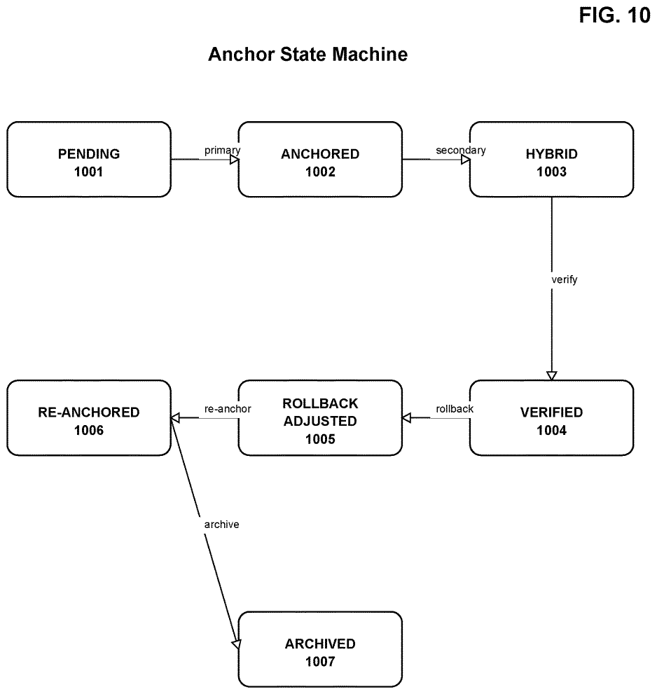

With respect to FIG. 10, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 10, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

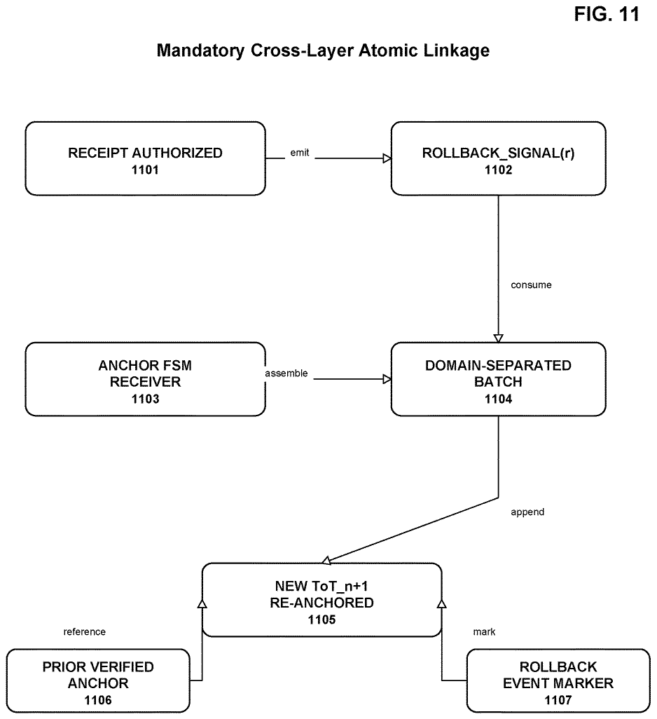

With respect to FIG. 11, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 11, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

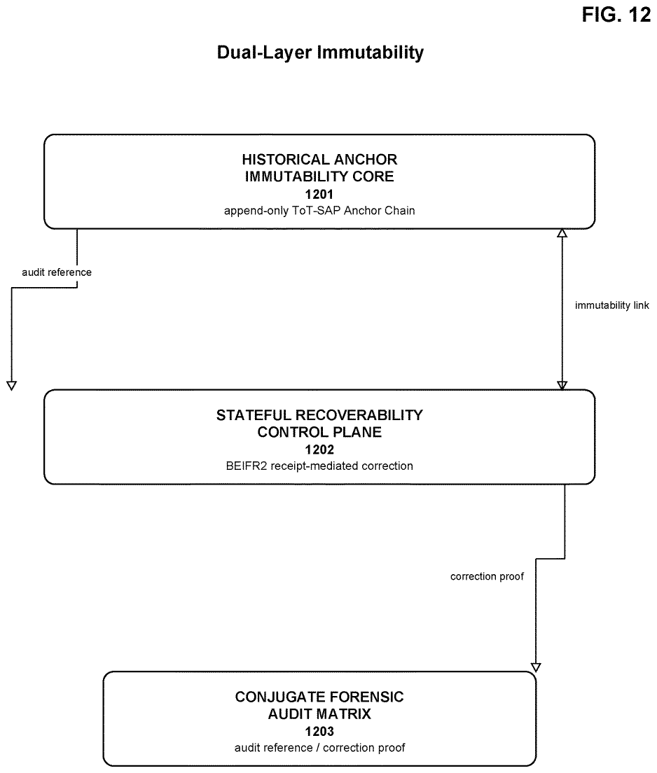

With respect to FIG. 12, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 12, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

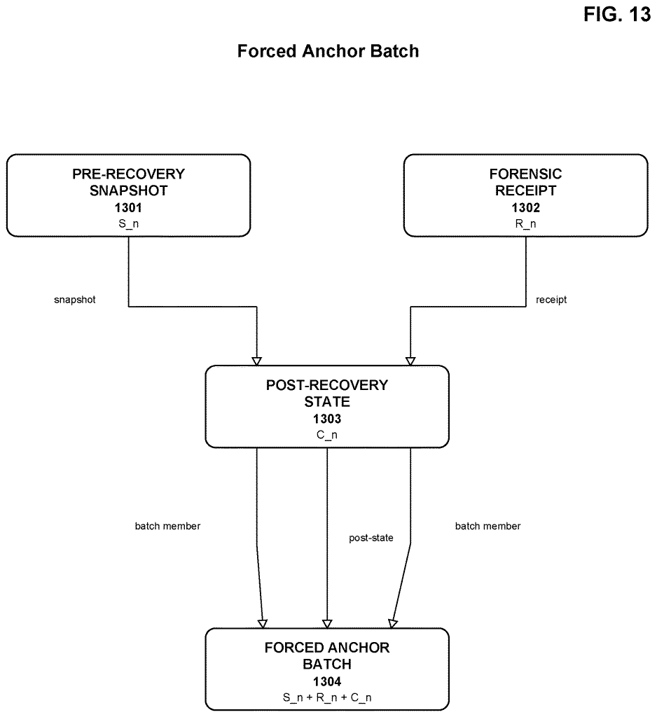

With respect to FIG. 13, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 13, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

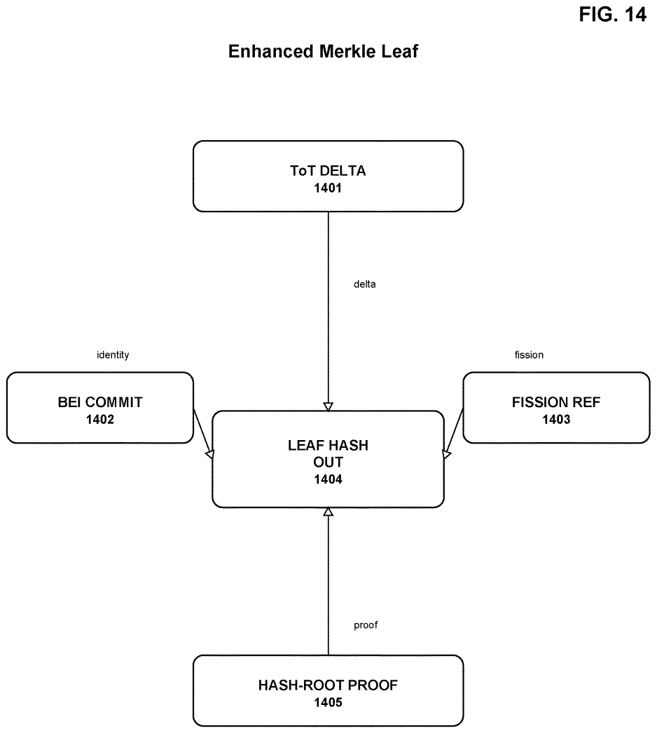

With respect to FIG. 14, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

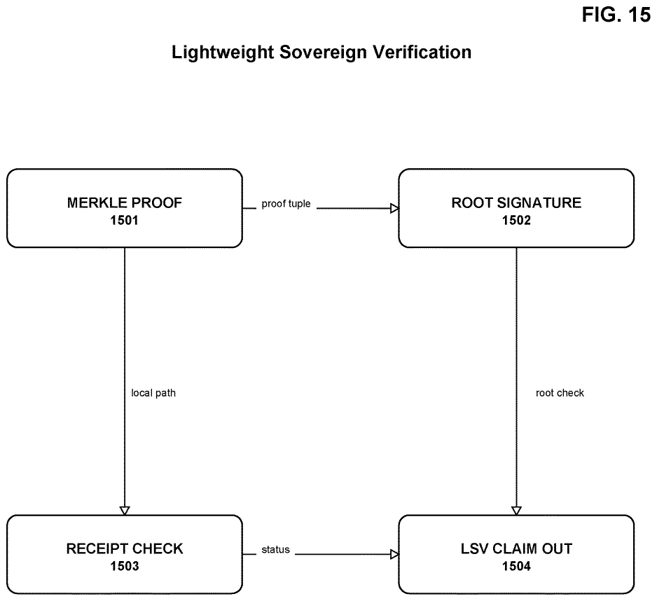

With respect to FIG. 15, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 15, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

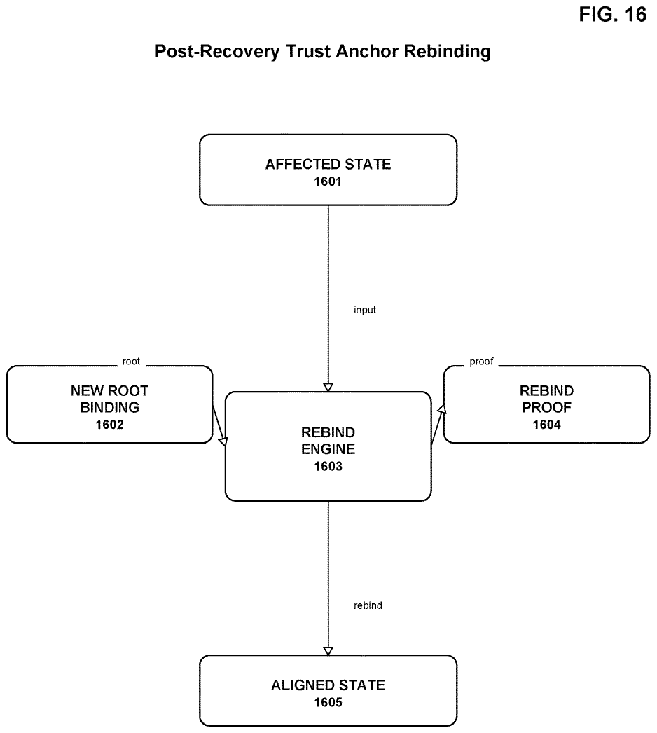

With respect to FIG. 16, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

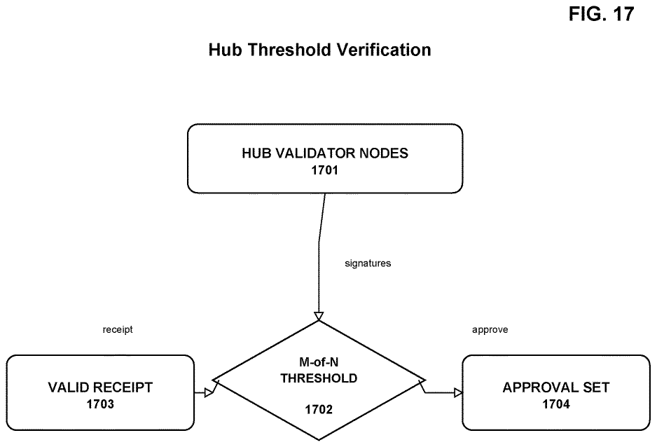

With respect to FIG. 17, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

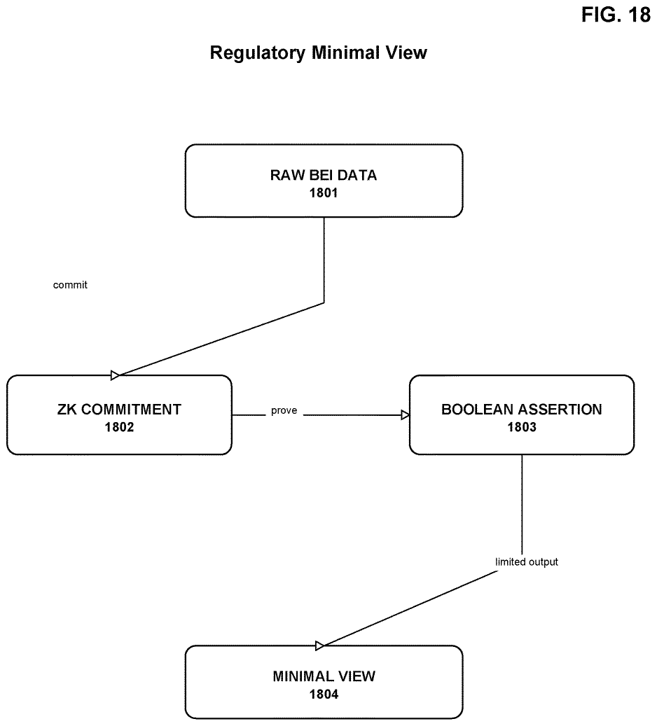

With respect to FIG. 18, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

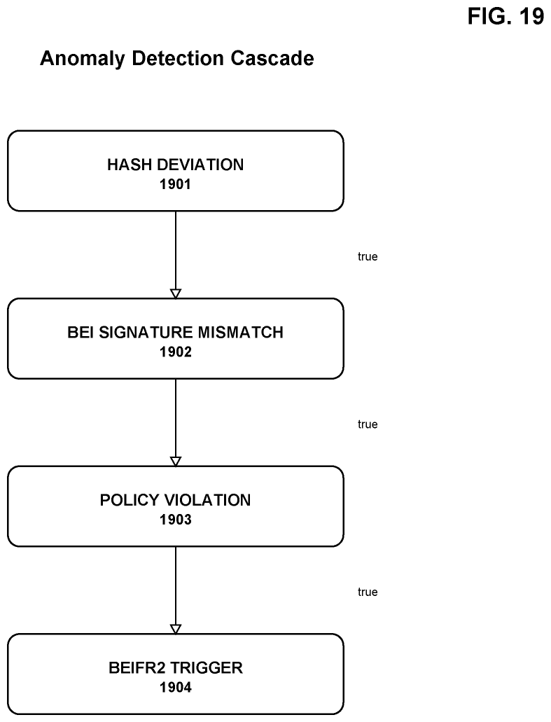

With respect to FIG. 19, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

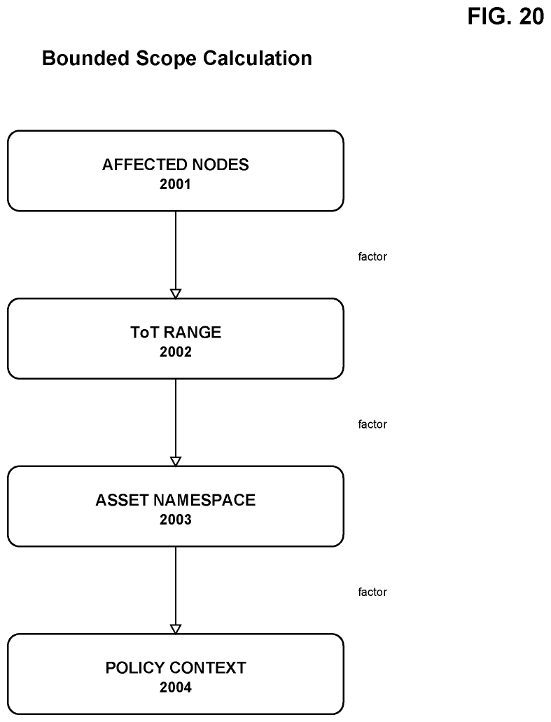

With respect to FIG. 20, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

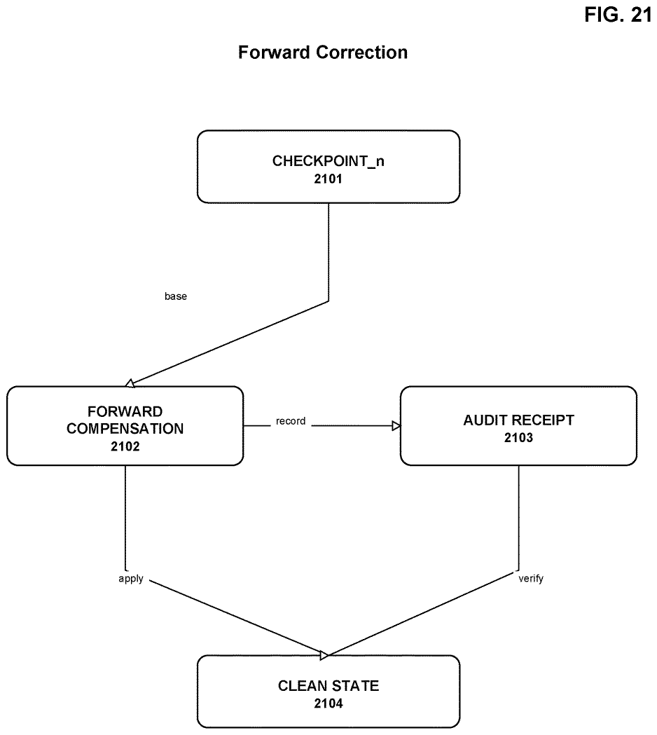

With respect to FIG. 21, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

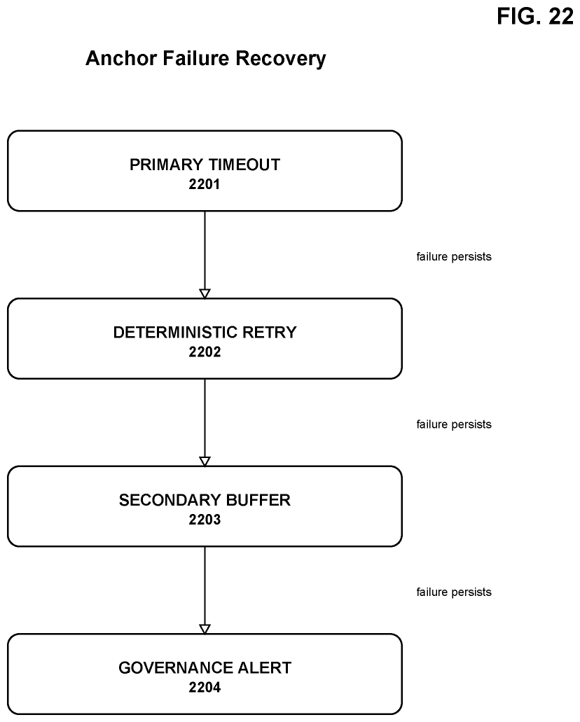

With respect to FIG. 22, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 22, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

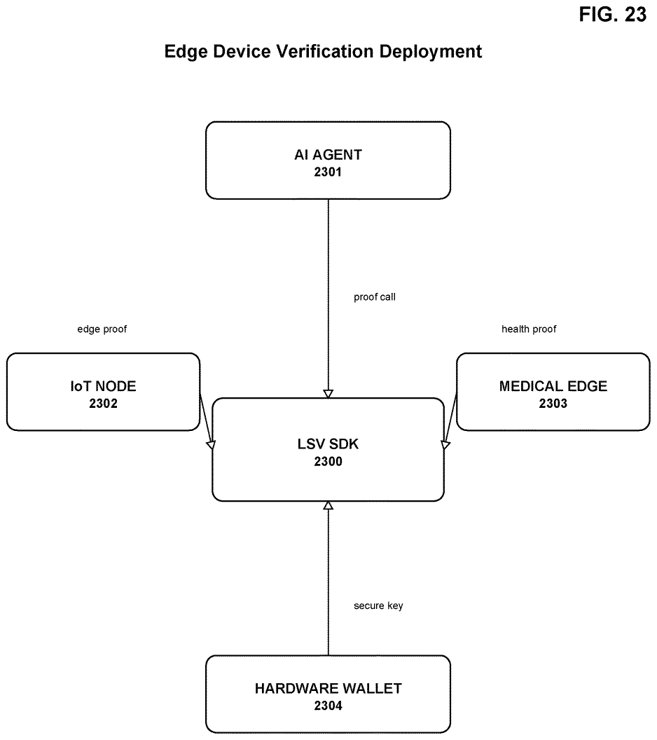

With respect to FIG. 23, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

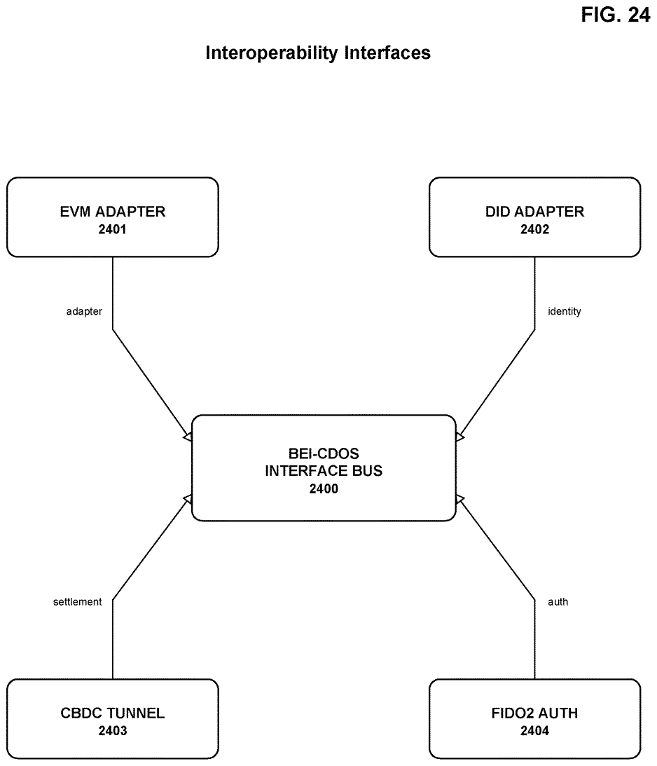

With respect to FIG. 24, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

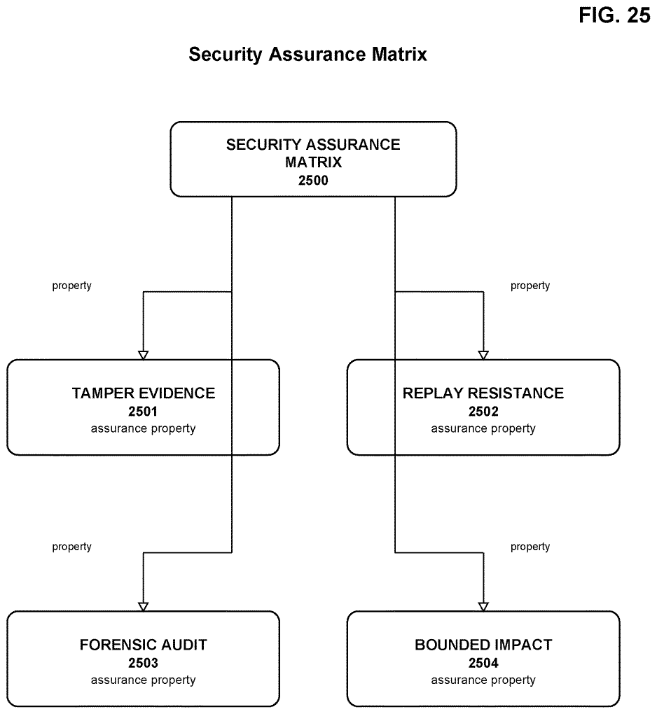

With respect to FIG. 25, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

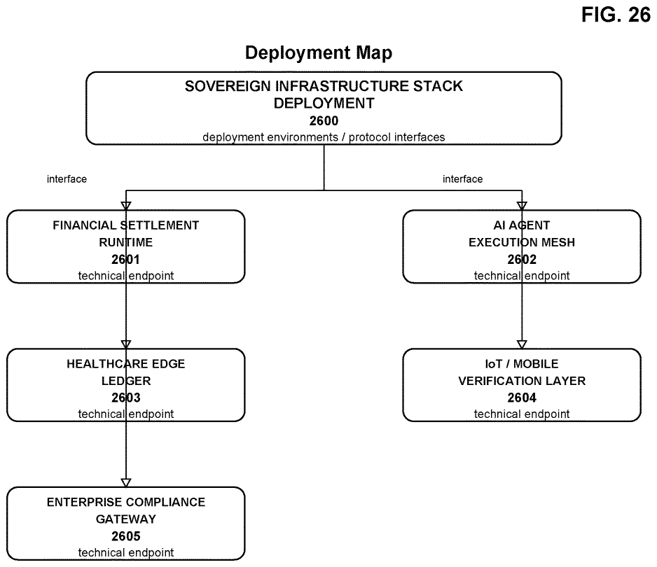

With respect to FIG. 26, the referenced modules and arrows are not decorative. Each block identifies a machine-executable component, state object, protocol layer, verification step, or data structure that participates in the disclosed control flow. The arrows identify data flow, control flow, state transition, anchoring transition, or verification dependency and correspond to the described protocol operations.

In implementations corresponding to FIG. 26, the illustrated components may be distributed across one or more processors and may communicate over secured channels. The component identifiers are used to align the drawing with the specification and claims, including the Rooted Domain Trust Anchor, BEI-CD Governance Bridge, BEIFR2 Recovery Tunnel, ToT-SAP Anchoring Protocol Engine, Forensic Receipt Object, and Lightweight Sovereign Verification layer when applicable.

### Expanded Embodiments and Figure-Linked Implementation Details

### Implementation Details for FIG. 1—Overall Architecture

FIG. 1 is implemented as a protocol-supporting drawing rather than as a conceptual business diagram. The illustrated the Rooted Domain Trust Anchor, BEI-CD Governance Bridge, BEIFR2 Recovery Tunnel, ToT-SAP Anchor Engine, and LSV Edge Verification layer correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 1, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 1 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 2—Five-Layer Protocol Stack

FIG. 2 is implemented as a protocol-supporting drawing rather than as a conceptual business diagram. The illustrated root, governance, recovery, temporal anchoring, and verification layers correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 2, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 2 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 3—Rooted Domain Trust Anchor

FIG. 3 is implemented as a protocol-supporting drawing rather than as a conceptual business diagram. The illustrated domain-origin root authority, policy hash, anchor key, and root signature correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 3, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 3 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 4—Bei-Cd Governance Bridge

FIG. 4 is implemented as a protocol-supporting drawing rather than as a conceptual business diagram. The illustrated central policy, mapping engine, decentralized state, and feedback proof correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 4, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 4 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 5—Tot Tuple Data Model

FIG. 5 is implemented as a protocol-supporting drawing rather than as a conceptual business diagram. The illustrated prior hash, ToT interval, value delta, and BEI binding correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 5, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 5 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 6—Tot-Sap Anchor Engine

FIG. 6 is implemented as a protocol-supporting drawing rather than as a conceptual business diagram. The illustrated anchor request, enhanced Merkle compilation, primary anchor, and secondary anchor correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 6, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 6 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 7—Beifr2 Recovery Tunnel

FIG. 7 is implemented as a protocol-supporting drawing rather than as a conceptual business diagram. The illustrated anomaly sentinel, state snapshot, receipt generator, and recovery plane correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 7, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 7 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 7, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 8—Forensic Receipt Object

FIG. 8 is implemented as a protocol-supporting drawing rather than as a conceptual business diagram. The illustrated snapshot hash, rollback scope, anchor reference, trigger vector, and receipt signature correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 8, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 8 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 8, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 9—Receipt State Machine

FIG. 9 is implemented as a protocol-supporting drawing rather than as a conceptual business diagram. The illustrated Created, Pending, Authorized, Executed, Anchored, and Finalized states correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 9, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 9 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 9, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 10—Anchor State Machine

FIG. 10 is implemented as a protocol-supporting drawing rather than as a conceptual business diagram. The illustrated Pending, Anchored, HybridAnchored, Verified, RollbackAdjusted, ReAnchored, and Archived states correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 10, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 10 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 10, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 11—Mandatory Cross-Layer Atomic Link

FIG. 11 is implemented as a protocol-supporting drawing rather than as a conceptual business diagram. The illustrated Receipt Authorized state, ROLLBACK_SIGNAL(r), Anchor FSM receiver, batch payload, and rollback-event marker correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 11, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 11 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 11, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 12—Dual-Layer Immutability

FIG. 12 is implemented as a protocol-supporting drawing rather than as a conceptual business diagram. The illustrated historical anchor immutability, stateful recoverability, and conjugate forensic audit matrix correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 12, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 12 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 12, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 13—Forced Anchor Batch

FIG. 13 is implemented as a protocol-supporting drawing rather than as a conceptual business diagram. The illustrated pre-recovery snapshot, Forensic Receipt Object, post-recovery state, and forced anchor batch correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 13, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 13 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 13, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 14—Enhanced Merkle Leaf

FIG. 14 is implemented as a protocol-supporting drawing rather than as a conceptual business diagram. The illustrated ToT delta, identity commitment, fission reference, receipt reference, policy hash, and nonce correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 14, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 14 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 14, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 15—Lightweight Sovereign Verification

FIG. 15 is implemented as a protocol-supporting drawing rather than as a conceptual business diagram. The illustrated Merkle proof, root signature, receipt check, and LSV claim output correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 15, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 15 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 15, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 16—Rebinding Logic

FIG. 16 is implemented as a protocol-supporting drawing rather than as a conceptual business diagram. The illustrated affected state, new root binding, rebind engine, and rebind proof correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 16, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 16 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 17—Hub Threshold Verification

FIG. 17 is implemented as a protocol-supporting drawing rather than as a conceptual business diagram. The illustrated hub nodes, threshold aggregator, valid receipt, and approval set correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 17, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 17 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 18—Regulatory Minimal View

FIG. 18 is implemented as a protocol-supporting drawing rather than as a conceptual business diagram. The illustrated raw BEI data, commitment module, boolean assertion, and minimal view correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 18, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 18 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 19—Anomaly Detection Cascade

FIG. 19 is implemented as a protocol-supporting drawing rather than as a conceptual business diagram. The illustrated hash deviation, identity mismatch, policy violation, and BEIFR2 trigger correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 19, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 19 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 20—Bounded Scope Calculation

FIG. 20 is implemented as a protocol-supporting drawing rather than as a conceptual business diagram. The illustrated affected nodes, ToT range, asset namespace, and policy context correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 20, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 20 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 21—Forward Correction Compensation

FIG. 21 is implemented as a protocol-supporting drawing rather than as a conceptual business diagram. The illustrated checkpoint, compensation vector, audit receipt, and clean state correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 21, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 21 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 22—Anchor Failure Recovery

FIG. 22 is implemented as a protocol-supporting drawing rather than as a conceptual business diagram. The illustrated primary timeout, deterministic retry, secondary buffer, governance alert, and reconciliation anchor correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 22, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 22 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

In FIG. 22, the illustrated logic is particularly relevant to the forced recovery-to-anchor linkage. A recovery operation is not complete merely because a state has been changed. A recovery operation becomes protocol-complete only when the evidence object, the relevant pre-recovery state commitment, and the post-recovery state commitment are bound into a retrievable anchor lineage that can be evaluated by later verifiers.

### Implementation Details for FIG. 23—Edge-Device Verification Deployment

FIG. 23 is implemented as a protocol-supporting drawing rather than as a conceptual business diagram. The illustrated AI agent, IoT node, medical edge, hardware wallet, and LSV SDK correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 23, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 23 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 24—Interoperability Interfaces

FIG. 24 is implemented as a protocol-supporting drawing rather than as a conceptual business diagram. The illustrated EVM adapter, DID adapter, CBDC tunnel, and FIDO2 authentication correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 24, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 24 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 25—Security Assurance Matrix

FIG. 25 is implemented as a protocol-supporting drawing rather than as a conceptual business diagram. The illustrated tamper evidence, replay resistance, forensic auditability, and bounded impact correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 25, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 25 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Implementation Details for FIG. 26—Deployment Map

FIG. 26 is implemented as a protocol-supporting drawing rather than as a conceptual business diagram. The illustrated financial settlement runtime, AI-agent execution mesh, healthcare edge ledger, IoT/mobile verification, and enterprise compliance gateway correspond to machine-readable states, cryptographic objects, network services, or verification routines. In an implementation, each illustrated block exposes an input interface, an output interface, a state variable, and at least one validation condition so that the drawing is directly supported by executable behavior.

For FIG. 26, a reference numeral identifies a component or object that can be instantiated in software, firmware, hardware, a trusted execution environment, a smart-contract adapter, a validator plugin, or an edge-verification library. The system can distribute those components across different machines, but the protocol semantics remain the same: root policy is converted into verifiable state constraints, recovery is receipt-mediated, and anchor records remain append-only.

The arrows in FIG. 26 identify a data-flow, control-flow, state-transition, proof-generation, anchoring, retry, or verification dependency. The arrows are not intended to imply a single physical cable or a single network topology. In some embodiments, the same logical flow is carried over a message bus, remote procedure call, smart-contract event, ledger transaction, secure enclave call, or embedded firmware interrupt.

### Detailed Message Formats

Root Policy Assertion may be encoded as a deterministic object containing at least the following fields when applicable: policy_id, policy_version, namespace_boundary, validity_interval, key_identifier, threshold_requirement, maximum_recovery_window, maximum_affected_asset_class, policy_hash, nonce, and root_signature. The encoding may be JSON, CBOR, TLV, protocol buffers, ASN.1, or another deterministic representation. Deterministic encoding allows a verifier to recompute a hash, compare a signature input, and reproduce the same Merkle leaf across heterogeneous implementations.

Divergence Interrupt Vector may be encoded as a deterministic object containing at least the following fields when applicable: divergence_type, metric_value, threshold_value, affected_namespace, candidate_scope, policy_reference, node_set_reference, trigger_nonce, and generated_time. The encoding may be JSON, CBOR, TLV, protocol buffers, ASN.1, or another deterministic representation. Deterministic encoding allows a verifier to recompute a hash, compare a signature input, and reproduce the same Merkle leaf across heterogeneous implementations.

Snapshot Object may be encoded as a deterministic object containing at least the following fields when applicable: snapshot_id, ToT_ledger_root, node_state_root, binding_table_root, policy_snapshot_hash, hub_validator_set_root, pending_queue_root, snapshot_time, and snapshot_signature. The encoding may be JSON, CBOR, TLV, protocol buffers, ASN.1, or another deterministic representation. Deterministic encoding allows a verifier to recompute a hash, compare a signature input, and reproduce the same Merkle leaf across heterogeneous implementations.

Receipt Authorization Message may be encoded as a deterministic object containing at least the following fields when applicable: receipt_id, snapshot_hash, rollback_scope_hash, trigger_vector_hash, hub_threshold_result, authorization_time, signer_set, signature_scheme, and receipt_hash. The encoding may be JSON, CBOR, TLV, protocol buffers, ASN.1, or another deterministic representation. Deterministic encoding allows a verifier to recompute a hash, compare a signature input, and reproduce the same Merkle leaf across heterogeneous implementations.

Anchor Request may be encoded as a deterministic object containing at least the following fields when applicable: request_id, anchor_context, batch_type, leaf_type_set, pre_recovery_snapshot_reference, receipt_reference, post_recovery_state_hash, policy_hash, anchor_mode, and requested_finality. The encoding may be JSON, CBOR, TLV, protocol buffers, ASN.1, or another deterministic representation. Deterministic encoding allows a verifier to recompute a hash, compare a signature input, and reproduce the same Merkle leaf across heterogeneous implementations.

Anchor Response may be encoded as a deterministic object containing at least the following fields when applicable: anchor_id, primary_anchor_reference, secondary_anchor_reference, Merkle_root, rollback_event_marker, receipt_identifier, anchor_state, retry_status, and anchor_signature. The encoding may be JSON, CBOR, TLV, protocol buffers, ASN.1, or another deterministic representation. Deterministic encoding allows a verifier to recompute a hash, compare a signature input, and reproduce the same Merkle leaf across heterogeneous implementations.

LSV Proof Bundle may be encoded as a deterministic object containing at least the following fields when applicable: asset_namespace, Merkle_path, anchor_reference, rooted_signature, receipt_reference, receipt_scope_proof, rebind_state_reference, and output_status. The encoding may be JSON, CBOR, TLV, protocol buffers, ASN.1, or another deterministic representation. Deterministic encoding allows a verifier to recompute a hash, compare a signature input, and reproduce the same Merkle leaf across heterogeneous implementations.

### Detailed State Transition Rules

The transition Receipt Created to Pending occurs when field assembly is complete and a preliminary receipt hash has been computed. If the condition fails, the state machine does not silently skip the transition. Instead, it records a rejected, pending, quarantined, or retry status so that later verification can determine whether a state was ordinary, corrected, pending-anchor, or untrusted.

The transition Receipt Pending to Authorized occurs when the required hub threshold, root policy check, liveness verification, replay prevention, and scope-safety validation succeed. If the condition fails, the state machine does not silently skip the transition. Instead, it records a rejected, pending, quarantined, or retry status so that later verification can determine whether a state was ordinary, corrected, pending-anchor, or untrusted.

The transition Receipt Authorized to Executed occurs when BEIFR2 applies the bounded forward corrective compensation vector to a localized runtime state. If the condition fails, the state machine does not silently skip the transition. Instead, it records a rejected, pending, quarantined, or retry status so that later verification can determine whether a state was ordinary, corrected, pending-anchor, or untrusted.

The transition Receipt Executed to Anchored occurs when ToT-SAP successfully anchors the pre-recovery snapshot, receipt, and post-recovery state in a unified batch. If the condition fails, the state machine does not silently skip the transition. Instead, it records a rejected, pending, quarantined, or retry status so that later verification can determine whether a state was ordinary, corrected, pending-anchor, or untrusted.

The transition Receipt Anchored to Finalized occurs when the audit window closes or a finality condition is met without unresolved challenge. If the condition fails, the state machine does not silently skip the transition. Instead, it records a rejected, pending, quarantined, or retry status so that later verification can determine whether a state was ordinary, corrected, pending-anchor, or untrusted.

The transition Anchor Pending to Anchored occurs when a primary anchor reference is created. If the condition fails, the state machine does not silently skip the transition. Instead, it records a rejected, pending, quarantined, or retry status so that later verification can determine whether a state was ordinary, corrected, pending-anchor, or untrusted.

The transition Anchor Anchored to HybridAnchored occurs when a secondary anchor reference is created or synchronized. If the condition fails, the state machine does not silently skip the transition. Instead, it records a rejected, pending, quarantined, or retry status so that later verification can determine whether a state was ordinary, corrected, pending-anchor, or untrusted.

The transition Anchor HybridAnchored to Verified occurs when root and optional secondary verification are satisfied. If the condition fails, the state machine does not silently skip the transition. Instead, it records a rejected, pending, quarantined, or retry status so that later verification can determine whether a state was ordinary, corrected, pending-anchor, or untrusted.

The transition Anchor Verified to RollbackAdjusted occurs when a rollback signal references the anchor lineage and a valid authorized receipt. If the condition fails, the state machine does not silently skip the transition. Instead, it records a rejected, pending, quarantined, or retry status so that later verification can determine whether a state was ordinary, corrected, pending-anchor, or untrusted.

The transition Anchor RollbackAdjusted to ReAnchored occurs when a post-correction state and corresponding receipt are appended as a new anchor record. If the condition fails, the state machine does not silently skip the transition. Instead, it records a rejected, pending, quarantined, or retry status so that later verification can determine whether a state was ordinary, corrected, pending-anchor, or untrusted.

The transition Anchor ReAnchored to Archived occurs when the audit window closes and the anchor lineage is preserved as historical evidence. If the condition fails, the state machine does not silently skip the transition. Instead, it records a rejected, pending, quarantined, or retry status so that later verification can determine whether a state was ordinary, corrected, pending-anchor, or untrusted.

### Additional Embodiments of Forced Linkage

In a financial settlement embodiment, a high-value tokenized asset can require hybrid anchoring before a corrected state becomes final. BEIFR2 may permit only a quarantine state until ToT-SAP produces both a primary anchor and a secondary timestamp or transparency-log proof. This embodiment illustrates implementation family 1, and the described features may be combined with any of the other embodiments unless such combination is technically inconsistent.

In an AI-agent execution embodiment, an autonomous agent can use LSV to verify whether a state is ordinary or receipt-adjusted before executing a payment, license call, model-access request, or resource-routing decision. The agent need not run a full consensus node. This embodiment illustrates implementation family 2, and the described features may be combined with any of the other embodiments unless such combination is technically inconsistent.

In a healthcare edge embodiment, a medical device can validate a corrected patient-data asset or consent token by checking a Merkle proof, rooted signature, and receipt scope. The device can accept a rebind state without downloading the full ledger history. This embodiment illustrates implementation family 3, and the described features may be combined with any of the other embodiments unless such combination is technically inconsistent.

In an IoT embodiment, a constrained sensor gateway can store only root keys, recent anchor references, and compact receipt material. It can reject stale or deviant states when a receipt indicates that the relevant namespace has been corrected. This embodiment illustrates implementation family 4, and the described features may be combined with any of the other embodiments unless such combination is technically inconsistent.

In an enterprise compliance embodiment, a regulatory minimal-view module can expose a boolean or limited assertion while preserving the underlying behavioral-economic data inside a secure boundary. The proof can be linked to the receipt and anchor lineage without exposing raw records. This embodiment illustrates implementation family 5, and the described features may be combined with any of the other embodiments unless such combination is technically inconsistent.

In a financial settlement embodiment, a high-value tokenized asset can require hybrid anchoring before a corrected state becomes final. BEIFR2 may permit only a quarantine state until ToT-SAP produces both a primary anchor and a secondary timestamp or transparency-log proof. This embodiment illustrates implementation family 6, and the described features may be combined with any of the other embodiments unless such combination is technically inconsistent.

In an AI-agent execution embodiment, an autonomous agent can use LSV to verify whether a state is ordinary or receipt-adjusted before executing a payment, license call, model-access request, or resource-routing decision. The agent need not run a full consensus node. This embodiment illustrates implementation family 7, and the described features may be combined with any of the other embodiments unless such combination is technically inconsistent.

In a healthcare edge embodiment, a medical device can validate a corrected patient-data asset or consent token by checking a Merkle proof, rooted signature, and receipt scope. The device can accept a rebind state without downloading the full ledger history. This embodiment illustrates implementation family 8, and the described features may be combined with any of the other embodiments unless such combination is technically inconsistent.

In an IoT embodiment, a constrained sensor gateway can store only root keys, recent anchor references, and compact receipt material. It can reject stale or deviant states when a receipt indicates that the relevant namespace has been corrected. This embodiment illustrates implementation family 9, and the described features may be combined with any of the other embodiments unless such combination is technically inconsistent.

In an enterprise compliance embodiment, a regulatory minimal-view module can expose a boolean or limited assertion while preserving the underlying behavioral-economic data inside a secure boundary. The proof can be linked to the receipt and anchor lineage without exposing raw records. This embodiment illustrates implementation family 10, and the described features may be combined with any of the other embodiments unless such combination is technically inconsistent.

In a financial settlement embodiment, a high-value tokenized asset can require hybrid anchoring before a corrected state becomes final. BEIFR2 may permit only a quarantine state until ToT-SAP produces both a primary anchor and a secondary timestamp or transparency-log proof. This embodiment illustrates implementation family 11, and the described features may be combined with any of the other embodiments unless such combination is technically inconsistent.

In an AI-agent execution embodiment, an autonomous agent can use LSV to verify whether a state is ordinary or receipt-adjusted before executing a payment, license call, model-access request, or resource-routing decision. The agent need not run a full consensus node. This embodiment illustrates implementation family 12, and the described features may be combined with any of the other embodiments unless such combination is technically inconsistent.

In a healthcare edge embodiment, a medical device can validate a corrected patient-data asset or consent token by checking a Merkle proof, rooted signature, and receipt scope. The device can accept a rebind state without downloading the full ledger history. This embodiment illustrates implementation family 13, and the described features may be combined with any of the other embodiments unless such combination is technically inconsistent.

In an IoT embodiment, a constrained sensor gateway can store only root keys, recent anchor references, and compact receipt material. It can reject stale or deviant states when a receipt indicates that the relevant namespace has been corrected. This embodiment illustrates implementation family 14, and the described features may be combined with any of the other embodiments unless such combination is technically inconsistent.

In an enterprise compliance embodiment, a regulatory minimal-view module can expose a boolean or limited assertion while preserving the underlying behavioral-economic data inside a secure boundary. The proof can be linked to the receipt and anchor lineage without exposing raw records. This embodiment illustrates implementation family 15, and the described features may be combined with any of the other embodiments unless such combination is technically inconsistent.

In a financial settlement embodiment, a high-value tokenized asset can require hybrid anchoring before a corrected state becomes final. BEIFR2 may permit only a quarantine state until ToT-SAP produces both a primary anchor and a secondary timestamp or transparency-log proof. This embodiment illustrates implementation family 16, and the described features may be combined with any of the other embodiments unless such combination is technically inconsistent.

In an AI-agent execution embodiment, an autonomous agent can use LSV to verify whether a state is ordinary or receipt-adjusted before executing a payment, license call, model-access request, or resource-routing decision. The agent need not run a full consensus node. This embodiment illustrates implementation family 17, and the described features may be combined with any of the other embodiments unless such combination is technically inconsistent.

In a healthcare edge embodiment, a medical device can validate a corrected patient-data asset or consent token by checking a Merkle proof, rooted signature, and receipt scope. The device can accept a rebind state without downloading the full ledger history. This embodiment illustrates implementation family 18, and the described features may be combined with any of the other embodiments unless such combination is technically inconsistent.

In an IoT embodiment, a constrained sensor gateway can store only root keys, recent anchor references, and compact receipt material. It can reject stale or deviant states when a receipt indicates that the relevant namespace has been corrected. This embodiment illustrates implementation family 19, and the described features may be combined with any of the other embodiments unless such combination is technically inconsistent.

In an enterprise compliance embodiment, a regulatory minimal-view module can expose a boolean or limited assertion while preserving the underlying behavioral-economic data inside a secure boundary. The proof can be linked to the receipt and anchor lineage without exposing raw records. This embodiment illustrates implementation family 20, and the described features may be combined with any of the other embodiments unless such combination is technically inconsistent.

In a financial settlement embodiment, a high-value tokenized asset can require hybrid anchoring before a corrected state becomes final. BEIFR2 may permit only a quarantine state until ToT-SAP produces both a primary anchor and a secondary timestamp or transparency-log proof. This embodiment illustrates implementation family 21, and the described features may be combined with any of the other embodiments unless such combination is technically inconsistent.

In an AI-agent execution embodiment, an autonomous agent can use LSV to verify whether a state is ordinary or receipt-adjusted before executing a payment, license call, model-access request, or resource-routing decision. The agent need not run a full consensus node. This embodiment illustrates implementation family 22, and the described features may be combined with any of the other embodiments unless such combination is technically inconsistent.

In a healthcare edge embodiment, a medical device can validate a corrected patient-data asset or consent token by checking a Merkle proof, rooted signature, and receipt scope. The device can accept a rebind state without downloading the full ledger history. This embodiment illustrates implementation family 23, and the described features may be combined with any of the other embodiments unless such combination is technically inconsistent.

In an IoT embodiment, a constrained sensor gateway can store only root keys, recent anchor references, and compact receipt material. It can reject stale or deviant states when a receipt indicates that the relevant namespace has been corrected. This embodiment illustrates implementation family 24, and the described features may be combined with any of the other embodiments unless such combination is technically inconsistent.

In an enterprise compliance embodiment, a regulatory minimal-view module can expose a boolean or limited assertion while preserving the underlying behavioral-economic data inside a secure boundary. The proof can be linked to the receipt and anchor lineage without exposing raw records. This embodiment illustrates implementation family 25, and the described features may be combined with any of the other embodiments unless such combination is technically inconsistent.

In a financial settlement embodiment, a high-value tokenized asset can require hybrid anchoring before a corrected state becomes final. BEIFR2 may permit only a quarantine state until ToT-SAP produces both a primary anchor and a secondary timestamp or transparency-log proof. This embodiment illustrates implementation family 26, and the described features may be combined with any of the other embodiments unless such combination is technically inconsistent.

In an AI-agent execution embodiment, an autonomous agent can use LSV to verify whether a state is ordinary or receipt-adjusted before executing a payment, license call, model-access request, or resource-routing decision. The agent need not run a full consensus node. This embodiment illustrates implementation family 27, and the described features may be combined with any of the other embodiments unless such combination is technically inconsistent.

In a healthcare edge embodiment, a medical device can validate a corrected patient-data asset or consent token by checking a Merkle proof, rooted signature, and receipt scope. The device can accept a rebind state without downloading the full ledger history. This embodiment illustrates implementation family 28, and the described features may be combined with any of the other embodiments unless such combination is technically inconsistent.

In an IoT embodiment, a constrained sensor gateway can store only root keys, recent anchor references, and compact receipt material. It can reject stale or deviant states when a receipt indicates that the relevant namespace has been corrected. This embodiment illustrates implementation family 29, and the described features may be combined with any of the other embodiments unless such combination is technically inconsistent.

In an enterprise compliance embodiment, a regulatory minimal-view module can expose a boolean or limited assertion while preserving the underlying behavioral-economic data inside a secure boundary. The proof can be linked to the receipt and anchor lineage without exposing raw records. This embodiment illustrates implementation family 30, and the described features may be combined with any of the other embodiments unless such combination is technically inconsistent.

### Claim Support and Enablement Notes

claim 1 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 2 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 3 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 4 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 5 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 6 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 7 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 8 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 9 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 10 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 11 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 12 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 13 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 14 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 15 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 16 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 17 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 18 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 19 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

Claim 20 is supported by the architecture, message formats, state machines, receipt fields, anchor transitions, failure states, and verification routines described above. In particular, the claim elements are implemented as machine-executable structures and operations rather than as abstract commercial arrangements. A person of ordinary skill in distributed computing, cryptography, ledger anchoring, and network operating systems can implement the elements using known serialization, hash, signature, state-machine, and message-passing technologies in view of the disclosure.

### ALTERNATIVE EMBODIMENTS AND VARIATIONS

Alternative embodiment 1 concerns hash functions. The disclosed protocol stack may use different technical choices for hash functions without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 2 concerns signature schemes. The disclosed protocol stack may use different technical choices for signature schemes without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 3 concerns anchor media. The disclosed protocol stack may use different technical choices for anchor media without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 4 concerns serialization formats. The disclosed protocol stack may use different technical choices for serialization formats without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 5 concerns hardware trust boundaries. The disclosed protocol stack may use different technical choices for hardware trust boundaries without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 6 concerns validator sets. The disclosed protocol stack may use different technical choices for validator sets without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 7 concerns receipt compression. The disclosed protocol stack may use different technical choices for receipt compression without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 8 concerns offline verification. The disclosed protocol stack may use different technical choices for offline verification without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 9 concerns secondary anchor reconciliation. The disclosed protocol stack may use different technical choices for secondary anchor reconciliation without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 10 concerns policy upgrade handling. The disclosed protocol stack may use different technical choices for policy upgrade handling without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 11 concerns namespace partitioning. The disclosed protocol stack may use different technical choices for namespace partitioning without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 12 concerns multi-tenant deployment. The disclosed protocol stack may use different technical choices for multi-tenant deployment without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 13 concerns post-quantum migration. The disclosed protocol stack may use different technical choices for post-quantum migration without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 14 concerns event logging. The disclosed protocol stack may use different technical choices for event logging without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 15 concerns firmware implementation. The disclosed protocol stack may use different technical choices for firmware implementation without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 16 concerns smart-contract implementation. The disclosed protocol stack may use different technical choices for smart-contract implementation without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 17 concerns kernel service implementation. The disclosed protocol stack may use different technical choices for kernel service implementation without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 18 concerns microservice implementation. The disclosed protocol stack may use different technical choices for microservice implementation without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 19 concerns secure enclave deployment. The disclosed protocol stack may use different technical choices for secure enclave deployment without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

Alternative embodiment 20 concerns archival proof storage. The disclosed protocol stack may use different technical choices for archival proof storage without departing from the forced linkage between receipt-mediated bounded recovery and append-only temporal anchoring. The important relationship is that a recovery event generates structured evidence and that the evidence is bound to the anchor lineage rather than being treated as an unanchored administrative note.

### Concluding Technical Effect

The disclosed system therefore provides a concrete network state control mechanism. It does not merely organize human activity or define a financial product. It modifies how distributed runtime errors are detected, bounded, corrected, recorded, anchored, retried, and verified. Historical records remain append-only while runtime state can be corrected through a cryptographically constrained and auditable path.

The resulting architecture supplies a technical bridge between centralized policy roots and decentralized execution environments. It enables a rooted authority to publish machine-verifiable constraints, enables decentralized systems to execute under those constraints, enables bounded correction when divergence occurs, and enables constrained devices to verify ordinary or corrected states using compact proof material.

### Additional Protocol Boundary Conditions

The system may treat each recovery operation as a bounded transaction over a defined namespace. The namespace may be a ledger partition, contract address range, account group, device class, domain-origin resource, medical record class, AI-agent workspace, settlement lane, or other machine-addressable boundary. A recovery request that cannot be mapped to a bounded namespace can be rejected or escalated.

In some embodiments, a policy assertion can define several recovery modes, including observation-only mode, quarantine mode, provisional correction mode, primary-anchor-required mode, hybrid-anchor-required mode, and emergency halt mode. These modes allow the same architecture to support both low-latency edge interaction and high-assurance settlement without changing the core receipt-to-anchor invariant.

The receipt object may be stored in full form, compact form, or hash-committed form. In compact form, an edge verifier may receive only fields required for local scope determination and signature validation. In full form, an auditor may receive additional trigger metrics, hub signatures, state hashes, policy references, and retry lineage.

An anchor record may include machine-readable finality status. Example values include pending, primary-anchored, hybrid-anchored, rollback-adjusted, re-anchored, reconciled, archived, and rejected. These values allow a verifier to distinguish an ordinary valid state from a state that is valid only after recovery, a state awaiting anchor reconciliation, or a state rejected for failed policy validation.

The forced linkage can be implemented synchronously or asynchronously. In synchronous implementations, recovery finalization waits for ToT-SAP anchor confirmation. In asynchronous implementations, the corrected runtime state can be placed into a quarantine or provisional state while ToT-SAP attempts primary or secondary anchoring. Both implementations preserve the requirement that finality is dependent on receipt-to-anchor reconciliation.

An implementation may use an event bus, secure queue, ledger event, kernel interrupt, smart-contract log, remote procedure call, or enclave message to carry ROLLBACK_SIGNAL(r). The signal itself can be signed and hash-committed to prevent spoofing. A receiver that cannot verify the signal signature can reject the anchor request before constructing an anchor payload.

The architecture permits parallelization. Snapshot capture, receipt field assembly, hub threshold collection, and enhanced Merkle leaf preparation may occur in parallel after the initial trigger is validated. However, final ordering is deterministic because the receipt hash, snapshot hash, post-state hash, policy hash, and nonce determine the anchor payload.

The system also supports audit reconstruction. An auditor can start from an asset namespace, identify relevant anchors, follow receipt identifiers, inspect bounded scopes, verify signatures, and determine whether each state transition was ordinary, receipt-adjusted, re-anchored, or archived. This reconstruction can be performed without trusting an off-chain narrative.

The disclosed technical effect is not dependent on a particular economic model. Whether the underlying network represents financial assets, identity assets, compute resources, medical device credentials, AI-agent permissions, or domain-origin rights, the same protocol relationship applies: rooted policy is mapped to decentralized execution, bounded divergence produces a receipt, and the receipt is forcibly anchored with pre-state and post-state commitments.

The specification therefore provides sufficient written description for systems, methods, and non-transitory media that implement the cross-layer atomic transaction. The terms Rooted Domain, BEI-CD, BEIFR2, ToT-SAP, Forensic Receipt Object, and LSV are described as machine-executable components, data structures, and state machines rather than as slogans or purely organizational labels.

1. A collaborative-governance digital asset sovereign operating system network, comprising: a Rooted Domain Trust Anchor Module configured to maintain an authoritative cryptographic root state and to issue signed control policy assertions; a BEI-CD Governance Bridge communicatively coupled to the Rooted Domain Trust Anchor Module and to a decentralized processing environment, the BEI-CD Governance Bridge being configured to map the control policy assertions into execution invariants and to receive feedback proofs from the decentralized processing environment; a BEIFR2 Recovery Tunnel Sub-system configured to detect a state divergence, create a cryptographic snapshot of a pre-recovery state, generate a Forensic Receipt Object, and execute a bounded forward corrective compensation transition; and a ToT-SAP Anchoring Protocol Engine configured to receive anchor requests and to construct an append-only anchor chain; wherein, upon the BEIFR2 Recovery Tunnel Sub-system generating or authorizing the Forensic Receipt Object, the BEIFR2 Recovery Tunnel Sub-system automatically and mandatorily invokes the ToT-SAP Anchoring Protocol Engine to anchor, as a unified domain-separated batch payload, at least the pre-recovery cryptographic snapshot, the Forensic Receipt Object, and a post-recovery state, and wherein a resulting anchor record in the anchor chain includes a rollback-event marker identifying that the anchor record corresponds to a bounded recovery operation while prior anchor records remain unmodified.

2. The system of claim 1, wherein the Rooted Domain Trust Anchor Module is configured to issue a signed policy assertion comprising a policy identifier, a policy version, a namespace boundary, a validity interval, a key identifier, a hub threshold requirement, a maximum recovery window, a maximum affected-asset class, and a root signature, and wherein the signed policy assertion is evaluated by the BEI-CD Governance Bridge before a recovery transition is permitted.

3. The system of claim 1, wherein the BEI-CD Governance Bridge is configured to perform a downward mapping operation that translates a Rooted Domain policy assertion into node-executable invariants and an upward mapping operation that translates a decentralized state proof, an anchor reference, a receipt hash, and a hub signature set into a root-verifiable feedback proof, such that the bridge establishes a bidirectional technical relationship rather than a human governance instruction.

4. The system of claim 1, wherein the ToT-SAP Anchoring Protocol Engine constructs each enhanced Merkle leaf using a domain separator, a serialized Time-of-Time value delta, a behavioral identity commitment, a fission reference, a hash-root proof, a receipt reference, a policy hash, and a nonce, so that a single Merkle proof can verify existence, temporal value inclusion, identity binding, fission tracking, and policy association.

5. The system of claim 1, wherein the BEIFR2 Recovery Tunnel Sub-system validates a recovery trigger by verifying liveness, replay prevention, policy authorization, anomaly scoring, bounded scope safety, and non-duplication of a trigger nonce, and wherein failure of any validation causes the recovery tunnel to reject or quarantine the recovery operation without finalizing a corrected state.

6. The system of claim 1, wherein the Forensic Receipt Object comprises a receipt identifier, a receipt type, a snapshot hash, a rollback scope, a trigger vector, a hub threshold record, an anchor reference, a rollback-event descriptor, a pre-recovery Time-of-Time summary, a post-recovery Time-of-Time summary, a rebind state, an audit window, a receipt hash, and a receipt signature, each field being serialized into a deterministic machine-readable representation before the receipt signature is generated.

7. The system of claim 1, wherein the BEIFR2 Recovery Tunnel Sub-system, after generating the Forensic Receipt Object, automatically invokes the ToT-SAP Anchoring Protocol Engine to anchor, as a unified batch payload, a pre-recovery Time-of-Time snapshot, the Forensic Receipt Object, and a post-recovery state object, and wherein a resulting anchor includes a rollback-event marker, a receipt identifier, a pre-recovery Time-of-Time summary, a post-recovery Time-of-Time summary, and a bounded rollback scope.

8. The system of claim 7, wherein the unified batch payload is assembled into an enhanced Merkle tree having at least a snapshot leaf, a receipt leaf, and a post-state leaf, and wherein each leaf uses a different domain separator to prevent substitution of a snapshot hash for a receipt hash, substitution of a receipt hash for a post-state hash, or substitution of a policy hash for an anchor hash.

9. The system of claim 1, wherein the ToT-SAP Anchoring Protocol Engine implements an Anchor State Machine comprising Pending, Anchored, HybridAnchored, Verified, RollbackAdjusted, ReAnchored, and Archived states, and wherein transitions among the states are triggered by primary anchor generation, secondary anchor synchronization, finality verification, rollback signal receipt, compensation commitment, re-anchor creation, and audit-window closure.

10. The system of claim 9, wherein a transition from Verified to RollbackAdjusted is triggered by a rollback signal emitted when the Forensic Receipt Object enters an authorized state, and wherein the rollback signal includes at least a receipt identifier, a snapshot hash, a bounded rollback scope, a policy hash, and a post-correction state hash.

11. The system of claim 9, wherein a transition from RollbackAdjusted to ReAnchored appends a new anchor record referencing the Forensic Receipt Object and a post-correction state hash without altering an earlier Verified anchor record, thereby preserving a visible recovery lineage in the historical anchor chain.

12. The system of claim 1, wherein primary anchor failure causes the Forensic Receipt Object to enter a pending-anchor status and causes the ToT-SAP Anchoring Protocol Engine to preserve the snapshot hash, receipt hash, post-correction state hash, retry counter, failure reason, and current anchor mode, and to schedule deterministic retry according to a policy-defined backoff rule.

13. The system of claim 12, wherein a secondary anchor stores a provisional proof during primary anchor failure, and wherein, after recovery of the primary anchor, the ToT-SAP Anchoring Protocol Engine generates a reconciliation anchor binding the provisional proof, the original receipt identifier, and the primary anchor reference into a final re-anchored state.

14. The system of claim 1, wherein multiple recovery events are recorded as a lineage of receipt identifiers, rollback-event anchors, prior anchor references, post-correction state hashes, and rebind-state identifiers, such that a verifier can reconstruct a sequence of recoveries without relying on off-chain human explanation.

15. The system of claim 1, further comprising a Lightweight Sovereign Verification layer configured to verify a digital asset state using a localized Merkle proof, a Rooted Domain signature, and a Forensic Receipt Object without synchronizing a full consensus ledger, and to output a verification claim indicating whether the digital asset state is ordinary, receipt-adjusted, pending-anchor, corrected-state, or archived.

16. The system of claim 15, wherein an edge device, edge processor module, firmware component, mobile secure enclave routine, hardware-wallet routine, vehicle computing unit, medical-device verifier, Internet-of-Things node, or autonomous AI-agent execution module determines whether a receipt scope includes an asset namespace, and, when the receipt scope includes the asset namespace, applies a rebind state or post-correction state hash identified by the Forensic Receipt Object to validate the corrected asset state under limited memory, limited connectivity, intermittent network conditions, or offline verification conditions, without executing or synchronizing a global consensus ledger state.

17. The system of claim 1, wherein a regulatory minimal-view module generates a cryptographic compliance assertion using zero-knowledge, commitment, or selective disclosure logic, so that a regulatory verification result is provided without exposing raw behavioral economic evidence contained in an underlying identity or value state record.

18. A computer-implemented method for executing collaborative state governance within a sovereign digital asset distributed network infrastructure, the method comprising: compiling, via a Rooted Domain Trust Anchor, an authoritative rule variant into a mathematical system invariant signature vector; mapping the mathematical system invariant signature vector dynamically to a decentralized execution plane through a BEI-CD bidirectional synchronization bridge; logging active transactional state transitions on the decentralized execution plane as sequential Time-of-Time data blocks under a ToT-SAP monotonic temporal anchoring protocol; constructing enhanced Merkle tree structures over Time-of-Time value deltas, behavioral identity commitments, fission references, hash-root proofs, receipt references, and anchor context fields; monitoring the sequential Time-of-Time data blocks through an automated cross-layer anomaly checking routine to extract a divergence metric; instantiating a bounded forensic recovery tunnel when the divergence metric violates an invariant condition defined by the mathematical system invariant signature vector; creating a cryptographic snapshot of a deviant runtime state; calculating a bounded recovery scope for affected nodes, assets, namespaces, state keys, and time intervals; generating a serialized Forensic Receipt Object encapsulating a cryptographic commitment of the deviant runtime state and a targeted recovery scope; authorizing the serialized Forensic Receipt Object in a recovery state machine; automatically triggering, in response to authorization of the serialized Forensic Receipt Object, an anchoring state machine to append a domain-separated batch containing a pre-recovery Time-of-Time snapshot, the serialized Forensic Receipt Object, and a post-correction recovered state; applying an algorithmic forward-correction compensation vector to reset a localized runtime environment to a verified checkpoint; marking the resulting anchor with a rollback-event marker and receipt identifier; rebinding the localized runtime environment to a Rooted Domain policy topology; and emitting an audit event while preserving continuity of all prior historical anchor blocks.

19. A non-transitory computer-readable storage medium comprising machine-executable program instructions that, when executed by one or more processors of a distributed operating system network, cause the one or more processors to: verify a Rooted Domain policy authority signature embedded within a distributed routing layer; maintain a real-time bidirectional rule-to-state synchronization mapping between a central identity framework and a decentralized node topology; assemble sequential data fragments into enhanced Merkle tree structures wherein each leaf node encapsulates a temporal delta value, a behavioral identity commitment signature, a cryptographic fission tracking reference, and a receipt reference; evaluate a divergence metric using at least one of hash deviation, identity mismatch, policy violation, anchor inconsistency, or temporal drift; halt state progression within a targeted decentralized execution thread upon receipt of an automated policy violation alert from an inline cryptographic sentinel; create a cryptographic snapshot of the targeted decentralized execution thread; generate a Forensic Receipt Object encoding a snapshot hash, rollback scope, trigger vector, hub threshold, anchor reference, rollback event, rebind state, audit window, and receipt signature; authorize the Forensic Receipt Object in a recovery state machine; automatically trigger an anchoring state machine, responsive to the authorization, to serialize the snapshot, the Forensic Receipt Object, and a restored state into an append-only anchor record without altering a prior anchor record; execute a BEIFR2 state-restoration sequence to rebind a localized active state to a Rooted Domain policy topology while maintaining structural continuity of pre-existing blocks in an underlying temporal value ledger; and output a machine-readable audit event identifying the append-only anchor record and the Forensic Receipt Object.

20. The non-transitory computer-readable storage medium of claim 19, wherein the program instructions further cause the one or more processors to perform lightweight sovereign verification by validating a Merkle proof, a Rooted Domain signature, and a Forensic Receipt Object for an edge device or edge processor module that does not process a global consensus ledger state, and by determining whether a receipt-defined rollback scope modifies a verified asset namespace before outputting a local acceptance, rejection, pending, corrected-state, or archived result.
